(19) United States
(12) Patent Application Publication
(10) Pub. No.: US 2025/0247691 A1
(43) Pub. Date: Jul. 31, 2025

(54) ENHANCED DATA PRIVACY MANAGEMENT

(71) Applicant: Cisco Technology, Inc., San Jose, CA (US)

(72) Inventors: Jerome Henry, Pittsboro, NC (US); Domenico Ficara, Ecublens (CH); Ugo Campiglio, Ecublens (CH); Javier Contreras, Barcelona (ES); Juan Carlos Zuniga, Montreal (CA); Stephen M. Orr, Wallkill, NY (US); Amine Choukir, Ecublens (CH)

(21) Appl. No.: 18/999,608

(22) Filed: Dec. 23, 2024

Related U.S. Application Data
(63) Continuation-in-part of application No. 18/793,705, filed on Aug. 2, 2024.
(60) Provisional application No. 63/633,024, filed on Apr. 11, 2024.
(60) Provisional application No. 63/564,811, filed on Mar. 13, 2024.
(60) Provisional application No. 63/625,230, filed on Jan. 25, 2024.

(51) Int. Cl. H04W 12/02; H04W 12/08

(52) U.S. Cl. CPC H04W 12/02; H04W 12/08

(57) ABSTRACT

Devices, systems, methods, and processes for facilitating enhanced data privacy (EDP) management are described herein. EDP management for effective obfuscation may be enabled with a wireless AP. The AP transmits wireless frames advertising support for group-based EDP. The AP transmits one or more epoch parameters associated with a plurality of epoch groups. A first epoch parameter comprises epoch timing information and a second epoch parameter indicates a number of wireless stations participating in the corresponding epoch group. The AP further receives a wireless action frame, transmitted by a wireless station, that indicates a first epoch group of the plurality of epoch groups that the STA requests to join. The AP maintains a wireless connection with the wireless station using a plurality of over-the-air (OTA) medium access control (MAC) addresses for the wireless station that are rotated at an epoch interval associated with the first epoch group.

### CROSS-REFERENCE TO RELATED APPLICATIONS

This application is a continuation-in-part of U.S. application Ser. No. 18/793,705, filed Aug. 2, 2024, which claims the benefit of and priority to U.S. Provisional Application No. 63/625,230, filed Jan. 25, 2024; Application No. 63/564,811, filed Mar. 13, 2024; and Application No. 63/633,024, filed Apr. 11, 2024; the entirety of each of which is incorporated herein by reference.

### FIELD

The present disclosure relates to wireless communication. More particularly, the present disclosure relates to address rotation management in wireless devices for enhanced data privacy.

### BACKGROUND

Wi-Fi provides seamless wireless connectivity for a multitude of devices in various environments such as homes, businesses, and public spaces. Certain advancements aim to enhance client privacy in wireless networks by enabling clients to avoid tracking through rotation of media access control (MAC) addresses. For example, the static nature of identifiers such as over-the-air MAC address (OTA MAC) and Association Identifier (AID) in Wi-Fi can raise privacy and security concerns. Fixed MAC addresses may allow third parties to track user movement within and across networks or profile device behaviors over time. Additionally, these static identifiers can pose security risks, such as making devices more vulnerable to spoofing, eavesdropping, and impersonation. It has been proposed that all stations (“STAs”) in a Basic Service Set (BSS) simultaneously change their MAC addresses at predefined epoch boundaries. For example, at epoch boundaries, an Access Point (AP) may signal all connected STAs (e.g., user devices, client devices, endpoint devices, etc.) to rotate their MAC addresses. Such coordinated MAC address rotation during each epoch boundary may obscure individual device identities and make it difficult for an eavesdropper to track individual devices.

However, eavesdroppers with surveillance equipment can monitor wireless local area network (WLAN) packets and track the activity of STAs associated with the WLAN. Thus, if an eavesdropper monitors a BSS over a time period, the eavesdropper can observe the sets of MAC addresses before and after the coordinated rotation. Although direct correlation to specific MAC addresses from one epoch to the next may not be possible, statistical methods can be utilized to identify STAs based on consistent traffic patterns. Further, it may be difficult to force an STA to rotate its MAC address. For example, the STA may have a privacy algorithm that requires slower address rotation, or the STA may be inactive at the end of the epoch, or the like. Such STAs may independently choose their epoch boundaries for MAC address rotation. Such inability to rotate MAC addresses and AIDs of the STAs forcefully also limits the AP's ability to adapt to network demands and user behavior, potentially straining resources.

While this avoids the challenges of forced synchronization, it can introduce a “confusion issue” where a limited change in MAC addresses during a small time interval can make it easier for an eavesdropper to track a specific device. Further, collision between two STAs during MAC address rotation can occur if both STAs randomly select the same MAC address simultaneously while being associated with the same Wi-Fi network. When STAs rotate their MAC addresses to enhance privacy, the STAs generate new, randomized MAC addresses that are ideally unique. However, the limited range of available local MAC addresses increases the likelihood of two STAs coincidentally selecting the same MAC address. If this happens and both STAs try to connect to the network simultaneously, the AP may misinterpret the two STAs as a single device, resulting in communication errors, failed connections, or even preventing one of the STAs from joining the network due to address conflict.

### SUMMARY OF THE DISCLOSURE

Methods and systems for facilitating enhanced data privacy management in accordance with embodiments of the disclosure are described herein. In many embodiments, a method comprises transmitting, by an access point, one or more wireless frames advertising support for enhanced data privacy (EDP). The one or more wireless frames indicate support for group-based EDP. The method further comprises transmitting, by the access point, one or more epoch parameters associated with a plurality of epoch groups. A first epoch parameter of the one or more epoch parameters comprises epoch timing information and a second epoch parameter of the one or more epoch parameters indicates a number of wireless stations participating in a corresponding epoch group of the plurality of epoch groups. The method further comprises receiving, by the access point, a wireless action frame transmitted by a wireless station. The wireless action frame indicates a first epoch group of the plurality of epoch groups that the wireless station requests to join. The method further comprises maintaining a wireless connection with the wireless station using a plurality of over-the-air (OTA) medium access control (MAC) addresses for the wireless station that are rotated at an epoch interval associated with the first epoch group.

In a number of embodiments, the method further includes transmitting, by the access point, a responsive wireless action frame to the wireless station. The responsive wireless action frame indicates acceptance of the wireless station into the first epoch group.

In a variety of embodiments, the one or more wireless frames advertising support for EDP are beacon frames.

In further embodiments, the one or more wireless frames advertising support for EDP are probe response frames.

In still further embodiments, the second epoch parameter identifies the number of wireless stations participating in the corresponding epoch group.

In more embodiments, the second epoch parameter identifies a percentage of associated wireless stations participating in the corresponding epoch group.

In still more embodiments, the one or more epoch parameters associated with the plurality of epoch groups are transmitted in one or more information elements of a wireless frame that advertises the one or more epoch parameters.

In additional embodiments, the one or more information elements each comprise reserved fields for the second epoch parameter.

In still additional embodiments, the reserved fields comprise one or more first octets identifying the number of wireless stations participating in the corresponding epoch group.

In numerous embodiments, the reserved fields further comprise one or more additional octets identifying a percentage of associated wireless stations participating in the corresponding epoch group.

In several additional embodiments, a wireless access point comprises at least one memory element for storing data, and at least one processor executing instructions associated with the data. Executing the instructions causes the wireless access point to perform operations, comprising transmitting one or more wireless frames advertising support for enhanced data privacy (EDP). The one or more wireless frames indicate support for group-based EDP. The operations further comprise transmitting one or more epoch parameters associated with a plurality of epoch groups. A first epoch parameter of the one or more epoch parameters comprises epoch timing information and a second epoch parameter of the one or more epoch parameters indicates a number of wireless stations participating in a corresponding epoch group of the plurality of epoch groups. The operations further comprise receiving a wireless action frame transmitted by a wireless station. The wireless action frame indicates a first epoch group of the plurality of epoch groups that the wireless station requests to join. The operations further comprise maintaining a wireless connection with the wireless station using a plurality of over-the-air (OTA) medium access control (MAC) addresses for the wireless station that are rotated at an epoch interval associated with the first epoch group.

In yet several embodiments, the operations further comprise transmitting a responsive wireless action frame to the wireless station, the responsive wireless action frame indicating acceptance of the wireless station into the first epoch group.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments in which an address rotation logic may operate in accordance with various embodiments of the disclosure;

FIG. 4 is a conceptual block diagram of a network architecture implementing address rotation for Enhanced Data Privacy (EDP) in accordance with various embodiments of the disclosure;

FIG. 5 is a diagram that illustrates a format of a wireless frame transmitted by a wireless device to advertise support for EDP in accordance with various embodiments of the disclosure;

FIG. 6 is a flow diagram that illustrates enhanced privacy capabilities element exchange between an access point (AP) and a wireless station (STA) in accordance with various embodiments of the disclosure;

FIG. 7 is a diagram that illustrates a message format of a wireless frame transmitted by an AP to communicate one or more epoch parameters of a default epoch group to an STA in accordance with various embodiments of the disclosure;

FIG. 8 is a diagram that illustrates a message format of a wireless frame transmitted by an AP to communicate one or more epoch parameters associated with a plurality of epoch groups to one or more STAs in accordance with various embodiments of the disclosure;

FIG. 9 is a diagram that illustrates a message format of a wireless action frame transmitted by a wireless device supporting EDP in accordance with various embodiments of the disclosure;

FIG. 10 is a diagram that illustrates a message format of a wireless frame transmitted by a wireless device participating in group-based EDP or individual-based EDP in accordance with various embodiments of the disclosure;

FIG. 11 is a flowchart depicting a process for transmitting a message for coordinating device address rotation in accordance with various embodiments of the disclosure;

FIG. 12 is a flowchart depicting a process for transmitting a message for coordinating device address rotation in accordance with various embodiments of the disclosure;

FIG. 13 is a flowchart depicting a process for facilitating device address rotation in accordance with various embodiments of the disclosure;

FIG. 14 is a flowchart depicting a process for address rotation in a device that supports EDP in accordance with various embodiments of the disclosure;

FIG. 15 is a flowchart depicting a process for trust-based address rotation in a wireless device in accordance with various embodiments of the disclosure;

FIG. 16 is a flowchart depicting a process for coordinating device address rotation in accordance with various embodiments of the disclosure;

FIG. 17 is a flowchart depicting a process for facilitating enhanced data privacy with group-based EDP in accordance with various embodiments of the disclosure;

FIG. 18 is a flowchart depicting a process for facilitating collision determination and avoidance during an EDP event in accordance with various embodiments of the disclosure; and

FIG. 19 is a conceptual block diagram of a device suitable for configuration with an address rotation logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can facilitate enhanced device address rotation in wireless networks. IEEE standard 802.11bi aims to enhance privacy in wireless networks by enabling stations “STAs” (e.g., user devices, network devices, endpoint devices, etc.) to avoid tracking through anonymization schemes (e.g., rotation of media access control “MAC” addresses or association identifiers “AIDs”). Device identifiers such as over-the-air MAC address (OTA MAC) and AIDs in traditional Wi-Fi are static in nature. That is to say, the identifiers generally stay the same for the duration of a session, making it easier for a wireless Access Point (AP) to identify and manage the STA. The static nature of OTA MAC and AID presents notable privacy and security issues. For example, fixed OTA MAC addresses can be exploited by third parties to track user movement within and across networks, raising privacy concerns. Security risks are also heightened, as static OTA MACs and AIDs make devices more vulnerable to MAC spoofing, eavesdropping, and impersonation attacks.

In a known implementation, an AP may signal all STAs in a Basic Service Set (BSS) to simultaneously change their MAC addresses or AIDs at predefined epoch boundaries. This coordinated MAC/AID address rotation may make it difficult for an eavesdropper to track individual devices. However, if an eavesdropper is monitoring the BSS, the eavesdropper can detect the MAC addresses or AIDs before and after the synchronized rotation. For example, an eavesdropper can understand that a sudden change in multiple MAC addresses or AIDs at a particular time instance in a network is due to MAC/AID address rotation, and not due to the arrival of new STAs or the departure of old STAs from the network. Though direct correlation of specific MAC addresses or AIDs from one epoch to the next might be challenging, statistical analysis can reveal an STA based on consistent traffic patterns. For example, there can be two sets of ‘N’ MAC addresses, one during a first epoch duration and one during a second epoch duration. An eavesdropper, in theory, may be unable to determine which MAC address in the first epoch duration is translated to which MAC address in the second epoch duration. However, if they know that the event was MAC address rotation, they can statistically identify STAs based on their traffic pattern.

In another implementation, STAs may be allowed to independently choose their epoch boundaries for MAC address rotation. However, such an approach may lead to overheads and increase processing complexity. In other words, group address rotation may be useful for obfuscation, but it may be difficult to force every STA to rotate its address. Further, because there is a limited number of MAC addresses available within a local MAC address range, two STAs may coincidentally generate the same MAC address for rotation. In such scenarios, the AP may confuse them for a single device, resulting in communication errors, failed connections, or even an inability for one of the devices to join the network due to address conflict.

Therefore, in order to enhance privacy in networks, the present disclosure provides a solution that overcomes the abovementioned problems by supporting both group address rotation and individual address rotation for enabling enhanced data privacy (EDP). The present disclosure may ensure sufficient participation in group address rotation to achieve effective obfuscation while also allowing STAs to select their address rotation preferences, and avoiding any collision between STAs involved in the address rotation. Consequently, potential eavesdroppers may be confused by such a hybrid address rotation approach, making it difficult to track STAs based on traffic patterns. In other words, the present disclosure balances enhanced privacy with practical considerations, such as varied STA behaviors and privacy algorithms, and offers a flexible, adaptable address rotation solution without imposing significant overhead or complexity.

“STAs” (for example, smartphones, laptops, tablets, smartwatches, smart appliances, wearable devices, Internet of Things “IoT” devices, or the like) in a wireless network may be required to participate in anonymization schemes by rotating their addresses (e.g., MAC addresses or changing their AIDs) for enhancing privacy. In other words, an STA may change its MAC address, AID, or both at certain time intervals to prevent tracking and profiling based on a static MAC address or AID.

The present disclosure provides a wireless AP that may coordinate address rotation of a plurality of STAs in a network to facilitate EDP while also allowing the plurality of STAs to select their address rotation preferences. The AP may include an address rotation logic that facilitates and manages address rotation of the plurality of STAs. In a variety of embodiments, the AP may be configured to transmit one or more wireless frames advertising support for EDP. The one or more wireless frames may indicate support for group-based EDP, individual-based EDP, or both. The wireless frames transmitted by the AP to advertise support for EDP can be, for example, beacon frames, probe response frames, or the like. Similar to the AP, an STA can also transmit one or more wireless frames advertising support for EDP, for example, group-based EDP, individual-based EDP, or both. In an example, the wireless frames transmitted by the STA may be a (Re)-association request. In many embodiments, a wireless frame advertising support for EDP may include at least one information element (IE), for example, an enhanced privacy capability element, among other IEs which indicates support for the group-based EDP, the individual-based EDP, or both. In a number of embodiments, the AP and the STA may exchange these wireless frames, advertising support for EDP, during a discovery phase.

In more embodiments, the AP may be further configured to transmit one or more epoch parameters associated with a plurality of epoch groups. An “epoch” in networking may refer to a defined time interval or event during which a plurality of STAs may simultaneously perform specific operations, for example, address rotation. STAs that have accepted to execute these specific operations at an epoch or at a periodic epoch may refer to an epoch group. In the context of EDP, STAs that have accepted to participate in coordinated address rotation at an epoch or at a periodic epoch may collectively form an epoch group. There can be multiple such epoch groups with different or varying periodic epochs. Thus, each epoch or periodic epoch may be associated with a specific epoch group. Each epoch or periodic epoch may be defined by corresponding epoch parameters. For example, epoch parameters associated with a first epoch group may include a first epoch parameter that indicates epoch timing information of the first epoch group and a second epoch parameter that indicates a number of wireless STAs participating in the first epoch group. For example, the second epoch parameter may identify the number of wireless STAs participating in the first epoch group, a percentage of associated STAs participating in the first epoch group, or both. Thus, if there are multiple such epoch groups, the AP may transmit the one or more epoch parameters associated with each of the plurality of epoch groups. In yet more embodiments, the one or more epoch parameters may be transmitted by the AP in one or more IEs of a wireless frame that advertises the one or more epoch parameters. For example, the one or more IEs may include an Enhanced Group Privacy Availability Element that signals a list of the plurality of epoch groups supported in the BSS of the AP and their associated one or more epoch parameters. Examples of such wireless frame may include a management frame, an announcement frames, a beacon frame, a unicast frame, broadcast frame, an action frame, or the like.

In still more embodiments, the AP may be further configured to receive a wireless action frame transmitted by an STA. In an example, the wireless action frame may be transmitted by the STA in response to the one or more epoch parameters transmitted by the AP. In some embodiments, the wireless action frame may indicate a target epoch group of the plurality of epoch groups that the STA requests to join. In further embodiments, the AP may be further configured to transmit a responsive wireless action frame to the STA. The responsive wireless action frame may indicate an acceptance of the STA into the target epoch group. Further, the AP may be configured to maintain a wireless connection with the STA using a plurality of OTA MAC addresses for the STA that are rotated at an epoch interval associated with the target epoch group. In some more embodiments, instead of indicating the acceptance of the STA into the target epoch group, the responsive wireless action frame can also indicate a rejection of the STA into the target epoch group. In certain embodiments, instead of participating in the group-based EDP, the STA can also request to participate in the individual-based EDP.

In still yet further embodiments, the AP may be configured to identify an OTA MAC address that a first STA is likely to utilize in an upcoming epoch interval (or forthcoming epoch, a future epoch). The AP may further determine whether the OTA MAC address that the first STA may utilize in the upcoming epoch interval may cause a collision with an OTA MAC address of a second STA. In other words, the AP may determine whether the identified OTA MAC address of the first STA is same as the OTA MAC address identified for the second STA for the upcoming epoch interval. Upon determining that the OTA MAC address of the first STA may cause a collision with the OTA MAC address of the second STA, the AP may transmit to the first STA, a wireless frame, for example, a collision warning frame, to instruct the first STA to skip the use of the OTA MAC address designated for the upcoming epoch interval, and use a MAC address designated for a subsequent epoch interval after the upcoming epoch interval. In an example, the wireless action frame may further indicate the upcoming epoch interval in which collision is determined and the subsequent epoch interval to the first STA.

Thus, the enhanced group address rotation at the epoch boundaries offers significant advantages, including enhanced privacy through mass rotation, user autonomy by allowing devices to choose whether to participate in address rotation, and informed decision-making. The mass address rotation of the devices makes a large anonymity set, increasing entropy that enables the devices to hide in the crowd. The participating devices can also opt to change their addresses (e.g., MAC addresses or other identifiers) based on an indication of how well the devices would hide in the crowd if they were to change their addresses, for example, indicated by the number of STAs in each epoch group. Further, any device may be able to opt for its own epoch parameters and can also avoid collision with other devices. This approach can improve network performance by optimizing management during coordinated address rotations, can reduce overhead by not mandating participation, and can adapt to varying levels of device involvement. Additionally, it encourages best practices for privacy and security, supports diverse environments, and remains scalable and efficient as the number of devices grows, thereby ensuring robust and secure network operations.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

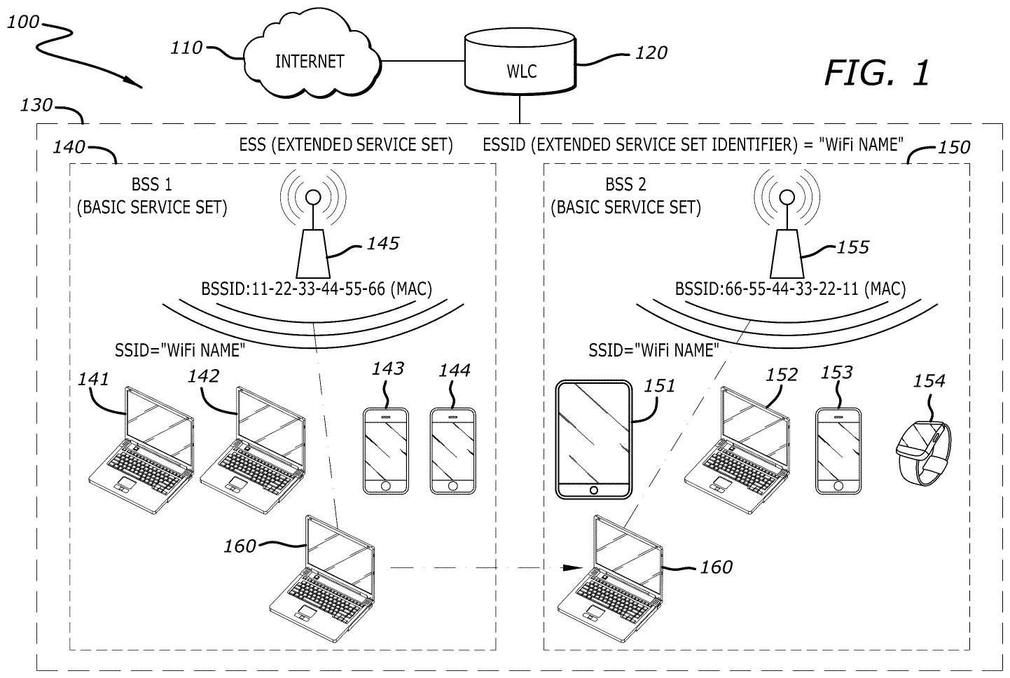

Referring to FIG. 1, a schematic block diagram of a wireless local networking system 100 in accordance with various embodiments of the disclosure is shown. Wireless local networking standards play a crucial role in enabling seamless communication and connectivity between various devices within localized areas. One of the most prevalent standards is Wi-Fi, which is based on the IEEE 802.11family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. The 802.11b (also referred to as 802.11High Rate or Wi-Fi) provides 11 Mbps transmission (with a fallback to 5.5, 2, and 1 Mbps) in the 2.4 GHz band. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes comprising devices like laptops, smartphones, or other Wi-Fi-enabled devices operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's important to note that a basic service set should not be confused with the coverage area of an access point (AP), which is referred to as the basic service area (BSA). The BSA encompasses the physical space within which an AP provides wireless coverage, while the basic service set focuses on the logical grouping of devices sharing common networking characteristics. This distinction emphasizes that the basic service set is a conceptual grouping based on shared communication parameters, while the basic service area defines the spatial extent of an AP's wireless reach. Understanding these distinctions is fundamental for effectively configuring and managing wireless networks, ensuring optimal performance and coordination among connected devices.

The service set identifier (SSID) defines a service set or extends a service set. Normally it is transmitted in the clear by stations in beacon packets to announce the presence of a network and seen by users as a wireless network name. Unlike basic service set identifiers, SSIDs are usually customizable. Since the contents of an SSID field are arbitrary, the 802.11standard permits devices to advertise the presence of a wireless network with beacon packets. A station may also likewise transmit packets in which the SSID field is set to null; this prompts an associated AP to send the station a list of supported SSIDs. Once a device has been associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single AP. This network is created through the collaboration of multiple APs, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single AP cannot adequately cover the entire desired area. By employing multiple APs strategically, users can move seamlessly across the extended service set without experiencing disruptions in connectivity. This is crucial for maintaining a consistent wireless experience in larger spaces, where users may transition between different physical locations covered by distinct APs.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

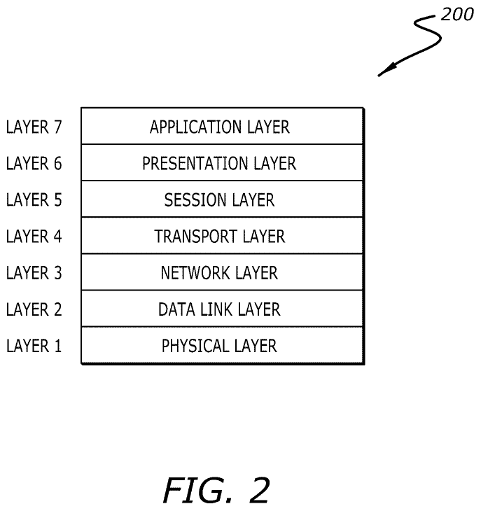

The network can include a variety of user end devices that connect to the network. These devices can sometimes be referred to as stations (i.e., “STAs”). Each device is typically configured with a medium access control (“MAC”) address in accordance with the IEEE 802.11standard. As described in more detail in FIG. 2, a physical layer can also be configured to communicate over the wireless medium, various devices on a network can include components such as a processor, transceiver, user interface, etc. These components can be configured to process frames of data transmitted and/or received over the wireless network. Wireless access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BSS 2 150). The ESS 130, a first BSS 1 140, and a second BSS 2 150 all transmit and are configured with the same SSID “Wi-Fi Name”, which can be a BSSID for each of the first BSS 1 140 and the second B 2 150 as well as an ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with a first AP 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). Each of these devices can communicate with a second AP 155. The third notebook 160 is communicatively collected to both the first BSS 1 140 and the second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-19 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance with the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with the embodiments of the disclosure. For example, various aspects described herein may reside or be carried out on one layer, or a plurality of layers. The elements depicted in FIG. 2 may also be interchangeable with other elements of FIGS. 1 and 3-19 as required to realize a particularly desired embodiment.

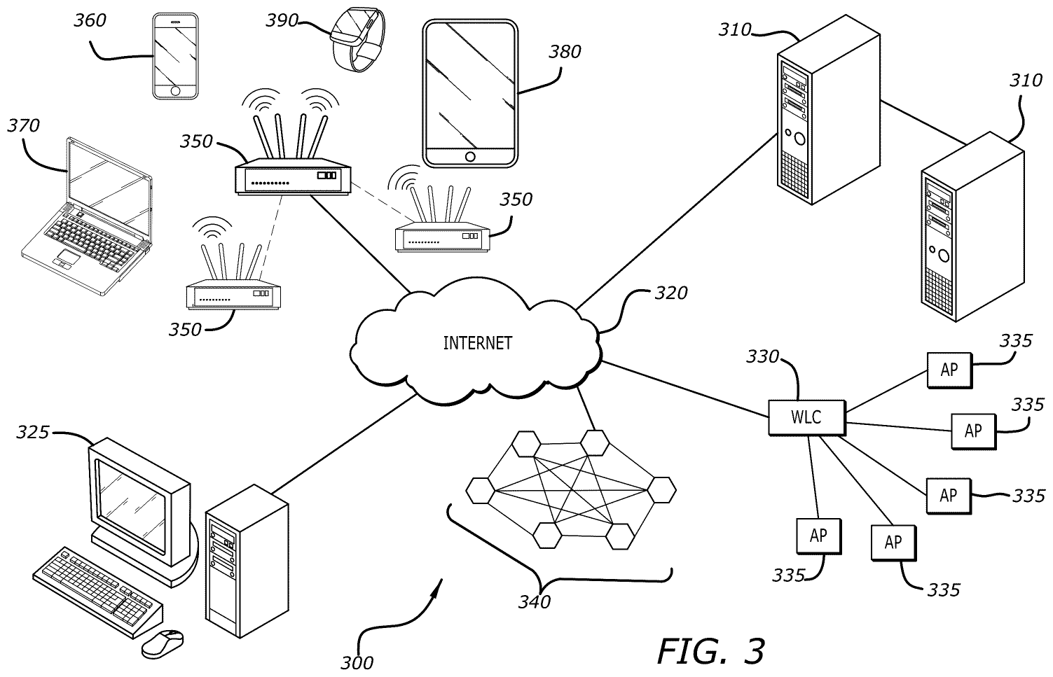

Referring to FIG. 3, a conceptual network diagram 300 of various environments in which an address rotation logic may operate in accordance with various embodiments of the disclosure is shown. Those skilled in the art will recognize that the address rotation logic can include various hardware and/or software deployments and can be configured in a variety of ways. In many embodiments, the address rotation logic can be configured as a standalone device, exist as a logic in another network device, be distributed among various network devices operating in tandem, or be remotely operated as part of a cloud-based network management tool. In further embodiments, one or more servers 310 can be configured with the address rotation logic or can otherwise operate as the address rotation logic. In many embodiments, the address rotation logic may operate on one or more servers 310 connected to a communication network 320 (shown as the “Internet”). The communication network 320 can include wired networks or wireless networks. The address rotation logic can be provided as a cloud-based service that can service remote networks, such as, but not limited to a deployed network 340.

However, in additional embodiments, the address rotation logic may be operated as a distributed logic across multiple network devices. In the embodiment depicted in FIG. 3, a plurality of network APs 350 can operate as the address rotation logic in a distributed manner or may have one specific device operate as the networking logic for all of the neighboring or sibling APs 350. The APs 350 may facilitate Wi-Fi connections for various electronic devices, such as but not limited to, mobile computing devices including laptop computers 370, cellular phones 360, portable tablet computers 380, and wearable computing devices 390.

In further embodiments, the address rotation logic may be integrated within another network device. In the embodiment depicted in FIG. 3, a wireless LAN controller (WLC) 330 may have an integrated address rotation logic that the WLC 330 can use to monitor or control power consumption of the APs 335 that the WLC 330 is connected to, either wired or wirelessly. In still more embodiments, a personal computer 325 may be utilized to access and/or manage various aspects of the address rotation logic, either remotely or within the network itself. In the embodiment depicted in FIG. 3, the personal computer 325 communicates over the communication network 320 and can access the address rotation logic of the servers 310, the network APs 350, or the WLC 330. In still more embodiments, the address rotation logic may be integrated into laptop computers 370, cellular phones 360, portable tablet computers 380, and wearable computing devices 390.

Although a specific embodiment for various environments that the address rotation logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the address rotation logic may be provided as a device or software separate from the WLC 330, or the address rotation logic may be integrated into the WLC 330. The elements depicted in FIG. 3 may also be interchangeable with other elements of FIGS. 1-2 and 4-19 as required to realize a particularly desired embodiment.

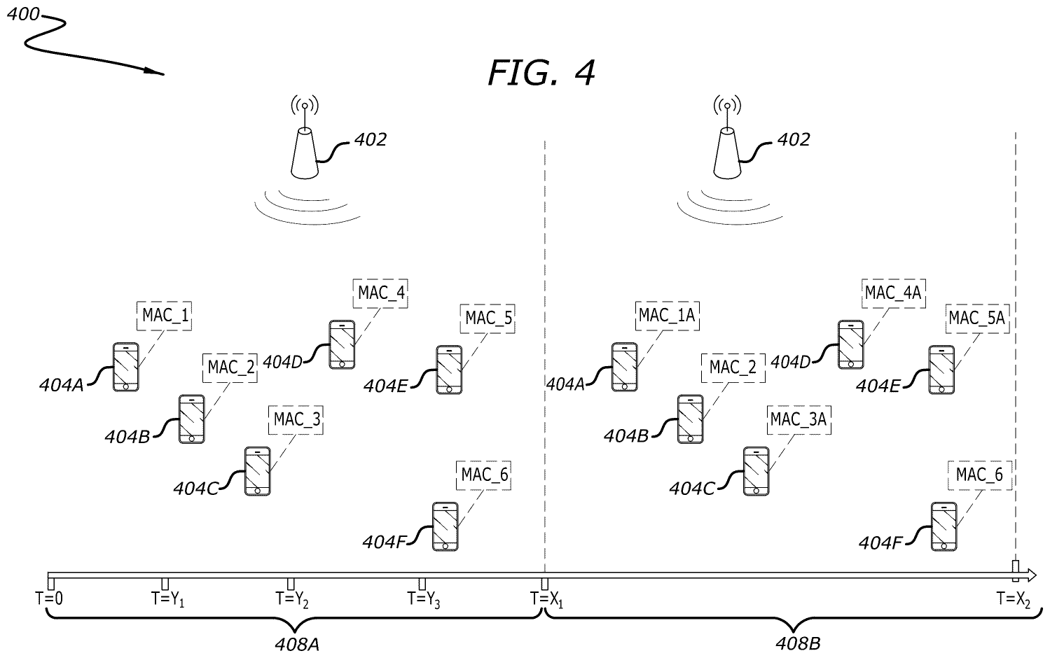

Referring to FIG. 4, a conceptual block diagram of a network architecture 400 implementing address rotation for enhanced data privacy (EDP) in accordance with various embodiments of the disclosure is shown. The embodiments shown in FIG. 4 may illustrate a scenario where an AP 402 may be deployed to provide network access to a plurality of network devices (for example, STAs 404A-F). In a non-limiting example, it is assumed that the AP 402 and the STAs 404A-F support EDP. In the embodiment depicted in FIG. 4, the AP 402 may include an address rotation logic configured to implement an anonymization scheme (for example, by coordinating MAC address rotation) for EDP. The address rotation logic can include various hardware and/or software deployments and can be configured in a variety of ways. For example, the address rotation logic can be a set of instructions stored within a non-volatile memory that, when executed by a processor(s) can carry out the steps to coordinate address rotation by the STAs 404A-F. For the sake of ongoing description, operations performed by the address rotation logic are considered as performed by the AP 402 as the address rotation logic is included in the AP 402.

In FIG. 4, various scenarios are depicted with respect to a time axis 406. The STAs 404A-F may be associated with their respective addresses, for example, over-the-air (OTA) MAC addresses. For example, during an epoch duration 408A between T=0 to T=X₁, the STA 404A has MAC address ‘MAC_1’, the STA 404B has MAC address ‘MAC_2’, the STA 404C has MAC address ‘MAC_3’, the STA 404D has MAC address ‘MAC_4’, and the STA 404E has MAC address ‘MAC_5’. Further, the STA 404F has MAC address ‘MAC_6’. Examples of the STAs 404A-F may include, but are not limited to, smartphones, laptops, tablets, smartwatches, smart appliances, wearable devices, Internet of Things “IoT” devices, or the like. In other words, the STAs 404A-F can be user devices, network devices, endpoint devices, client devices, or the like.

In order to provide privacy and prevent tracking of the STAs 404A-F, in many embodiments, the AP 402 may be configured to announce time schedules (for example, epoch timing information) for performing coordinated address rotations (e.g., group-based EDP). In a number of embodiments, the AP 402 may be configured to identify one or more upcoming time intervals (for example, T=X₁ and T=X₂) for scheduling the address rotations. The AP 402 may plan and identify the upcoming time intervals to ensure coordinated address rotation among a sufficient number of STAs. The upcoming time intervals may include, for example, planned epoch boundaries, next bus indices, or next bus announcements for performing address rotation. In other words, the upcoming time intervals (for example, T=X₁ and T=X₂) may refer to epoch boundaries or epoch intervals of epoch durations 408A and 408B at which one or more of the STAs 404A-F may change their MAC addresses and/or association identifiers (AID) to enhance privacy. The “AID” may refer to a unique identifier assigned by the AP 402 to each STA 404A-F when the STAs 404A-F associate with the AP 402. The AID may be used for internal tracking and managing an STA's connection with the AP 402.

In additional embodiments, the AP 402 may be configured to set a threshold count on a minimum number of STAs that have to participate in address rotation within a given time interval. STAs that have agreed to participate in address rotation within a given time interval for EDP may collectively refer to as an epoch group. There may be multiple such epoch groups associated with the AP 402, each epoch group having corresponding periodic epochs boundaries. Setting the threshold count may provide a crowd obfuscation parameter by ensuring that each epoch group includes a sufficient number of STAs that change their MAC addresses at the same epoch interval. Thus, enhancing the effectiveness of “hiding in the crowd.” In other words, the threshold count may ensure that the STAs 404A-F are secured from eavesdroppers monitoring the network due to the minimum number of STAs changing their MAC addresses within each epoch interval. For the sake of brevity, FIG. 4 is described with respect to one epoch group that includes the STAs 404A-F and is associated with the upcoming time intervals X₁ and X₂.

In a variety of embodiments, the AP 402 may transmit a message indicating the upcoming time intervals X₁ and X₂ for address rotation and threshold counts set for the respective upcoming time intervals X₁ and X₂. In various embodiments, the message may be transmitted as a wireless frame, for example, a management frame, an announcement frame, a beacon frame, a probe response frame, or the like. In many examples, the message may be broadcasted. In many additional examples, the message may be unicasted to the associated STAs 404A-F. In one or more embodiments, the wireless frame may include one or more information elements that include information regarding one or more epoch parameters associated with the epoch group. For example, the message may include a first epoch parameter indicating epoch timing information, such as the upcoming time intervals X₁ and X₂, associated with the epoch group. The epoch timing information may indicate an expected start time (also referred to as “timestamp”) of each one or more upcoming time intervals X₁ and X₂. Further, the message may include a second epoch parameter which may indicate a number or a count of STAs that are participating in an address rotation at each of the one or more upcoming time intervals X₁ and X₂. In other words, the second epoch parameter may indicate the number of STAs in the epoch group associated with the one or more upcoming time intervals X₁ and X₂. In a scenario where the AP 402 is associated with multiple such epoch groups, the transmitted message may include the first epoch parameter and the second epoch parameter associated with each of the epoch groups. In an example, the AP 402 may transmit the message at a time instance T=0.

In numerous embodiments, the AP 402 may be configured to encrypt the message before transmitting the message. Encrypting the message prior to transmitting may ensure that only authorized devices are able to access the message. The AP 402 may utilize one or more known encryption technologies, for example, symmetric key encryption, asymmetric key encryption, HASH-based encryption, or the like. Further, the AP 402 may ensure that the transmitted message is decryptable by the STAs 404A-F.

In more embodiments, prior to transmitting the message, the AP 402 may be further configured to determine a historical count of network devices that had participated in address rotation in a historical time interval (for example, prior to the upcoming time intervals X₁ and X₂) associated with the epoch group. In such embodiments, the transmitted message may be further configured to indicate the historical count of network devices as one of the epoch parameters associated with the epoch group. For example, some network devices may have opted to participate in address rotation at the historical time interval but failed to change their MAC addresses or AIDs at the historical time interval, while other network devices may not have opted but still changed their MAC addresses and/or AIDs at the historical time interval. Thus, the transmitted message may provide an estimate of an actual number of network devices that changed their MAC addresses and/or AIDs within the historical time interval. In numerous additional embodiments, the transmitted message may be further configured to indicate whether the threshold count was reached within the historical time interval, as one of the epoch parameters associated with the epoch group. For example, by indicating, in the transmitted message, whether the threshold count was reached within the historical time interval, the AP 402 may indirectly indicate a likelihood of the threshold count being satisfied within the upcoming time intervals X₁ and X₂ as well. In several embodiments, whether the threshold count was reached within the historical time interval can be indicated by a flag (e.g., a Boolean flag) in the transmitted message. For example, if the threshold count was satisfied within the historical time interval, the flag can be set to “1”; however, if the threshold count was not satisfied within the historical time interval, the flag can be set to “0”.

In further embodiments, the STAs 404A-F may receive the transmitted message and determine whether to participate in address rotation in the upcoming time intervals X₁ and X₂. In an example scenario, the STAs 404A, 404C, 404D, and 404E may determine to participate in address rotation within the upcoming time intervals X₁ and X₂, while the STAs 404B and 404F may determine to opt out of participating in the address rotation within the upcoming time interval X₁. For example, the STAs 404B and 404F may exit the epoch group to either join another epoch group or perform individual-based EDP instead of group-based EDP. Group-based EDP may correspond to an anonymization scheme where multiple STAs change their MAC addresses concurrently at planned epochs and individual-based EDP may correspond to another anonymization scheme where individual STAs independently change their MAC addresses based on STA-specific setting, without coordination or synchronization with other STAs.

Accordingly, the STAs 404A-F may transmit responses to the AP 402 indicating their intention of whether to participate or not in the address rotation within the upcoming time intervals. In an example, the responses can be transmitted via wireless action frames. In several additional embodiments, some STAs may not provide any response to the transmitted message and continue with their previously selected option related to EDP. In several more embodiments, the AP 402 may receive the responses from the STAs 404A-F. In still more embodiments, the AP 402 may further collect and aggregate the responses from the STAs 404A-F. Based on the responses that confirm participation in the address rotation, for example, within the upcoming time intervals X₁ and X₂, the AP 402 may determine whether the minimum threshold count set for the upcoming time intervals X₁ and X₂ is satisfied or not. For example, the AP 402 may have set a threshold count of ‘3’ for the upcoming time interval X₁. In such a scenario, if ‘4’ STAs have responded to participate in the address rotation within the upcoming time interval X₁, the AP 402 may establish that the threshold count is satisfied for the upcoming time interval X₁, and the address rotation proceeds. Thus, ensuring there is a significant number of STAs changing their MAC addresses and/or AIDs simultaneously to maintain the crowd obfuscation parameter. If, however, only ‘3’ STAs have opted to change their MAC addresses and/or AIDs, the AP 402 may delay the address rotation within the upcoming time interval X₁ until more STAs join, ensuring the threshold count is satisfied. The change in the upcoming time interval X₁ may be indicated in a follow-up message transmitted by the AP 402. In the current example, the AP 402 may determine that ‘4’ STAs (e.g., the STAs 404A, 404C 404D, and 404E) have opted to participate in the address rotation within the upcoming time interval X₁.

In still additional embodiments, the AP 402 may be further configured to re-transmit the message by including the determined count of network devices that have opted to participate in the address rotation within the upcoming time intervals X₁ and X₂. In other words, if there is any change related to the epoch parameters associated with the epoch group, the AP 402 may re-transmit the message to advertise the latest epoch parameters associated with the epoch group. In the current example, since STA 404B and 404F have exited the epoch group, the AP 402 may re-transmit the message with a latest number of STAs in the epoch group. Such inclusion of the updated count of the network devices in the transmitted message may prompt (e.g., encourage) more STAs to participate in the address rotation within the upcoming time intervals X₁ and X₂. In still further embodiments, the AP 402 may re-transmit the updated message, with the count of network devices, at a time interval T=Y₁. Based on the responses received to the re-transmitted message, the AP 402 may determine a new count of network devices that have opted to participate in the address rotation within the upcoming time intervals X₁ and X₂, and update the message for subsequent re-transmit. For example, the AP 402 may re-transmit the message with the updated count of network devices at time intervals T=Y₂ and Y₃.

In many further embodiments, the AP 402 may re-transmit the message based on whether the minimum threshold counts set for the upcoming time intervals X₁ and X₂ are satisfied or not. For example, if the minimum threshold count set for the upcoming time interval X₁ is satisfied after the re-transmit time interval T=Y₁, the AP 402 may not re-transmit the message at subsequent time intervals T=Y₂, Y₃. In many additional embodiments, the AP 402 may set the frequency of re-transmit based on a difference between the minimum threshold count set for an upcoming time interval and corresponding count of network devices that have opted to participate in the address rotation. For example, if the count of network devices that have opted to participate in the address rotation within the upcoming time interval X₁ is significantly lower than the minimum threshold count set for the upcoming time interval X₁, the AP 402 may increase the frequency of re-transmit. However, if the count of network devices that have opted to participate in the address rotation within the upcoming time interval X₁ is equal to or greater than the minimum threshold count set for the upcoming time interval X₁, the AP 402 may maintain default frequency or reduce the frequency of re-transmit.

In yet more embodiments, the AP 402 may be further configured to transmit a notification prior to the upcoming time interval X₁ and X₂. This notification may be configured to alert the STAs 404A-F about the upcoming time intervals X₁ and X₂ for the address rotation. By providing an advance alert notification, the AP 402 may ensure that STAs 404A-F are prepared and aware of the scheduled address rotation, thus facilitating smoother coordination and maximum participation. In an example, the AP 402 transmits the notification a predetermined duration (for example, 1 minute, 10 seconds, or the like) before the upcoming time interval X₁. In many additional embodiments, the AP 402 may be configured to determine a likelihood of possible collisions in MAC addresses of two or more STAs during the upcoming time intervals X₁ and X₂. Upon determination of collision, the AP 402 may transmit a collision warning action frame to colliding STAs as a collision warning before the upcoming time interval X₁. In an example, the collision warning action frame may instruct the colliding STAs to skip an address rotation in the upcoming time interval X₁, and to directly undergo the address rotation in a subsequent epoch interval (e.g., X₂). In further examples, the collision warning action frame may instruct the colliding STAs to skip changing to the colliding MAC address and instead change to alternate non-colliding MAC addresses in the upcoming time interval X₁.

Further, in a non-limiting example shown in FIG. 4, at the epoch boundary T=X₁, one or more STAs in the epoch group may be sleeping and may fail to change their MAC addresses as communicated to the AP 402. Further, one or more other STAs that had not opted to participate in the address rotation at T=X₁ may change their MAC addresses. As shown in FIG. 4, at T=X₁, the STAs 404A, 404C, 404D, and 404E have changed their MAC addresses, while the STAs 404B and 404F did not change their MAC addresses. Thus, during the epoch duration 408B between T=X₁ to T=X₂, the STA 404A has ‘MAC_1A’ as the new MAC address, the STA 404B has ‘MAC_2’ as the old MAC address, the STA 404C has ‘MAC_3A’ as the new MAC address, the STA 404D has ‘MAC_4A’ as the new MAC address, and the STA 404F has ‘MAC_6’ as the old MAC address. Thus, the AP 402 may be configured to maintain a wireless connection with each of the STAs 404A, 404C, 404D, and 404E using a plurality of OTA MAC addresses for the corresponding STA that are rotated at the upcoming time interval X₁ associated with the epoch group. For example, at the upcoming time interval X₁, the AP 402 may maintain a wireless connection with the STA 404A using the OTA MAC addresses ‘MAC_1’ and ‘MAC_1A’ that are rotated at the upcoming time interval X₁ associated with the epoch group that the STA 404A is a part of.

In still yet more embodiments, the AP 402 may consider T=X₁ as the historical time interval for the upcoming time interval X₂. In still yet further embodiments, the AP 402 may determine a historical count of network devices that had participated in the address rotation within the historical time interval X₁. In the current example, the historical count of network devices that had participated in the address rotation within the historical time interval X₁ is determined as ‘4’. Further, since the historical count of network devices that participated in the address rotation at the historical time interval X₁ exceeded the threshold count ‘3’, the AP 402 may set the flag to ‘1’ when transmitting a new message for the upcoming time interval X₂ and so on.

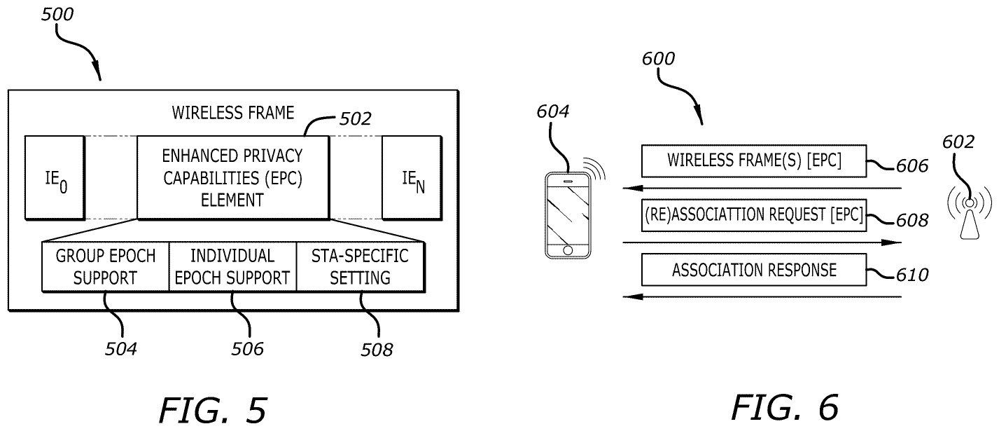

In various embodiments, the AP 402 and the STAs 404A-404F may exchange various wireless frames with each other (for example, during discovery phase or association phase) to advertise support for EDP such as group-based EDP, individual-based EDP, or both. Further, the STAs 404A-404F may transmit one or more wireless action frames to the AP 402 to indicate a change in previously initiated group-based EDP or individual-based EDP. Examples of various wireless frames or wireless action frames exchanged between an AP and an STA to facilitate EDP are described later in conjunction with FIGS. 5 and 7-10.

Although a specific embodiment for a network architecture implementing address rotation for EDP suitable for carrying out the various steps, processes, methods, and operations described herein is discussed with respect to FIG. 4, any of a variety of systems and/or processes may be utilized in accordance with embodiments of the disclosure. For example, the above-described operations performed by the AP 402 can also be performed by another network device, an STA, a WLC, or the like. In such a scenario, the STA may assume the role of a ‘leader’ STA and transmit a message announcing the intent of the leader STA to rotate its MAC address at an upcoming time interval. The leader STA may receive one or more responses from one or more other STAs regarding their intent to join the leader STA for address rotation. In such a scenario, instead of the AP initiating the group-based EDP, a first STA can transmit (e.g., broadcast) one or more epoch parameters associated with individual-based EDP and change to group-based EDP if other STAs also join the first STA to rotate their MAC addresses as per the transmitted epoch parameters. The elements depicted in FIG. 4 may also be interchangeable with other elements of FIGS. 1-3 and 4-19 as required to realize a particularly desired embodiment.

Referring to FIG. 5, a diagram that illustrates a format of a wireless frame 500 transmitted by a wireless device to advertise support for EDP in accordance with various embodiments of the disclosure is shown. In a number of embodiments, the wireless frame 500 may include one or more information elements. For example, as shown in FIG. 5, the wireless frame 500 includes information elements IE₀-IE_{N}. In a scenario where the wireless frame 500 is transmitted to advertise support for EDP, the wireless frame 500 may also include a specialized information element, for example, an enhanced privacy capabilities (EPC) element 502, to indicate EDP support, e.g., support for anonymization and privacy protection features.

In a number of embodiments, the EPC element 502 may include one or more fields to indicate support for group-based EDP, individual-based EDP, or both. For example, the EPC element 502 may include a group epoch support 504 field to indicate whether the wireless device supports group-based EDP and an individual epoch support 506 field to indicate whether the wireless device supports individual-based EDP. In an example, the group epoch support 504 and the individual epoch support 506 fields may be Boolean fields (e.g., flags) which can be set or reset as per EDP capabilities of the wireless device.

In an example scenario, if the wireless device supports group-based EDP, the group epoch support 504 field can be set to “1”, “True”, or “ON”. Likewise, if the wireless device supports individual-based EDP, the individual epoch support 506 field can be set to “1”, “True”, or “ON”. However, if the wireless device does not support group-based EDP, the group epoch support 504 field can be set to “0”, “False”, or “OFF”. Likewise, if the wireless device does not support individual-based EDP, the individual epoch support 506 field can be set to “0”, “False”, or “OFF”. Thus, if the wireless device supports both group-based EDP and individual-based EDP, both the group epoch support 504 and the individual epoch support 506 fields can be set to “1”. Though in the above example scenario, “1”, “True” “ON” are designated to indicate support and “0”, “False”, or “OFF” to indicate lack of support, the assignment can be reversed without departing from the scope of the disclosure.

In more embodiments, the wireless device may be an STA (e.g., a user device, a client device, an endpoint device, etc.) which includes an address rotation logic to facilitate and manage address rotation. The STA may transmit the wireless frame 500 to advertise support for EDP. The STA can support group-based EDP, individual-based EDP, or both. In certain embodiments, the wireless frame 500 transmitted by the STA may be a (Re)-association request.

In a variety of embodiments, the wireless device may be a wireless AP which includes an address rotation logic to facilitate and manage address rotation of a plurality of STAs. The AP may transmit the wireless frame 500 to advertise support for EDP. The AP can support group-based EDP, individual-based EDP, or both. In some embodiments, the wireless frame 500 transmitted by the AP may be a beacon frame. In some more embodiments, the wireless frame 500 transmitted by the AP may be a probe response frame. In additional embodiments, the EPC element 502 may also include an STA-specific setting 508 field. The STA-specific setting 508 field may be a Boolean field, which can be set to “1”, “True”, “ON” to indicate that the AP supports STA-specific settings for different epoch time intervals.

Although a specific embodiment for a wireless frame transmitted by a wireless device to advertise support for EDP suitable for carrying out the various steps, processes, methods, and operations described herein is discussed with respect to FIG. 5, any of a variety of systems and/or processes may be utilized in accordance with embodiments of the disclosure. For example, the AP and the STA may exchange wireless frames 500 to advertise support for EDP during a discovery phase. The elements depicted in FIG. 5 may also be interchangeable with other elements of FIGS. 1-4 and 6-19 as required to realize a particularly desired embodiment.

Referring to FIG. 6, a flow diagram 600 that illustrates EPC element exchange between an AP 602 and an STA 604 in accordance with various embodiments of the disclosure is shown. In many embodiments, the EPC element exchange between the AP 602 and the STA 604 may occur during a discovery phase.

In a number of embodiments, the AP 602 may transmit one or more wireless frames 606 advertising support for EDP. The wireless frame(s) 606 may include at least one information element, for example, an EPC element, among other information elements which indicates support for group-based EDP, individual-based EDP, or both. The wireless frame(s) 606 can be, for example, beacon frames, probe response frames, or the like. In a scenario where the wireless frame(s) 606 are beacon frames, the wireless frame(s) 606 can be broadcasted by the AP 602. However, if the wireless frame(s) 606 are probe response frames, the wireless frame(s) 606 can be unicasted by the AP 602 to the STA 604 as responses to one or more probe requests of the STA 604.

In a variety of embodiments, the STA 604 may transmit a (Re)-association request 608 to the AP 602. The (Re)-association request 608 may include at least one information element, for example, an EPC element, among other IEs to advertise support for EDP. Based on the capabilities of the STA 604, the (Re)-association request 608 can indicate support for group-based EDP, individual-based EDP, or both via the EPC element. In more embodiments, the AP 602 may transmit an association response 610 to the STA 604 based on the (Re)-association request 608.

Although a specific embodiment for EPC element exchange between an AP and an STA suitable for carrying out the various steps, processes, methods, and operations described herein is discussed with respect to FIG. 6, any of a variety of systems and/or processes may be utilized in accordance with embodiments of the disclosure. For example, the association response 610 can indicate a successful association or a failed association. The elements depicted in FIG. 6 may also be interchangeable with other elements of FIGS. 1-5 and 7-19 as required to realize a particularly desired embodiment.

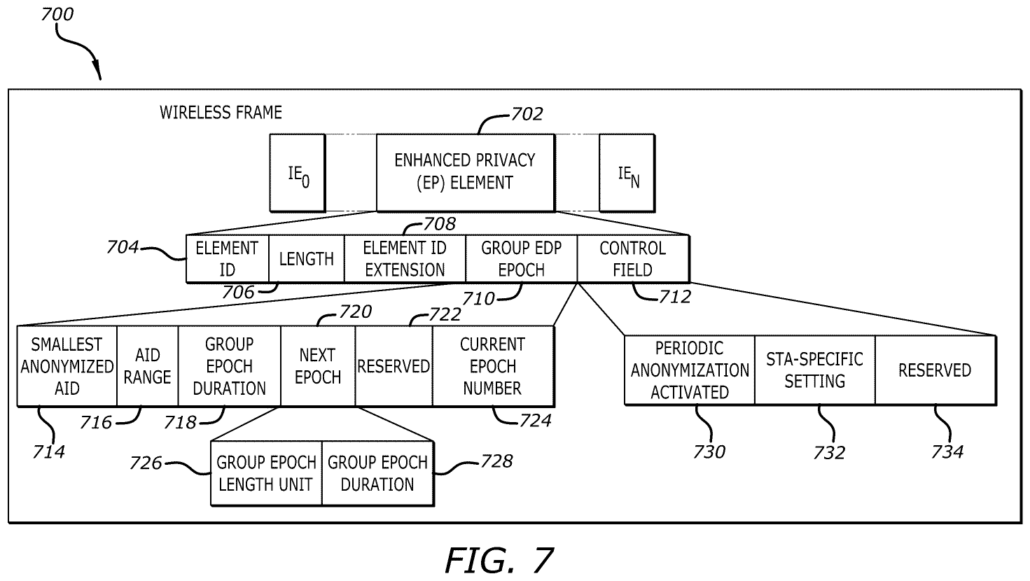

Referring to FIG. 7, a diagram that illustrates a message format of a wireless frame 700 transmitted by an AP to communicate one or more epoch parameters of a default epoch group to an STA in accordance with various embodiments of the disclosure is shown. An “epoch” in networking may refer to a defined time interval or event during which one or more STAs may perform specific operations, for example, address rotation.

In a number of embodiments, during a discovery phase, the AP may receive a (Re)-association request frame from the STA. Upon receiving the (Re)-association request frame, the AP may inspect the (Re)-association request frame for presence of an EPC element advertising support for EDP, such as group-based EDP. In a scenario where the (Re)-association request frame includes the EPC element indicating support for group-based EDP, the AP may understand that the STA supports group-based EDP. In such a scenario, if the association between the AP and the STA is successful, the AP may, for example, automatically, assign the STA to a default epoch group. An epoch group may include a plurality of STAs that share a synchronized schedule (e.g., periodic epochs) for performing certain coordinated actions, for example, changing OTA-MAC addresses, to enhance collective privacy. In a variety of embodiments, the default epoch group may be specifically designated for automatic handling of periodic anonymization and may be identified using, for example, a Group ID 0. In a number of embodiments, upon successful association, the AP may further assign an AID value to the STA. The AID value may be a unique value, selected from a range reserved exclusively for the default epoch group. In more embodiments, the AP may assign the AID value based on a BSS-specific offset associated with the AP. The BSS-specific offset may be added to an initial AID value, selected from the range reserved exclusively for the default epoch group, to obtain a final AID value for assigning to the STA. For example, if the AP is associated with a base offset of ‘1000’, and the initial AID value is ‘3’, the AP may assign an AID value of ‘1003’ to the STA.

In yet more embodiments, upon successful assignment of the STA to the default epoch group, the AP may transmit one or more epoch parameters associated with the default epoch group to the STA. In an example, the AP may transmit the one or more epoch parameters associated with the default epoch group during a 4-way handshake that is a part of the association process. More specifically, the AP may transmit the one or more epoch parameters within an M3 frame during the 4-way handshake.

In still more embodiments, the one or more epoch parameters associated with the default epoch group and the assigned AID value may be transmitted in one or more information elements of the wireless frame 700. As shown in FIG. 7, the wireless frame 700 includes information elements IE₀-IE_{N}. In a scenario where the wireless frame 700 is transmitted to communicate the one or more epoch parameters of the default epoch group and the assigned AID value, the wireless frame 700 may also include a specialized information element, for example, an enhanced privacy (EP) element 702. The EP element 702 may include a plurality of fields and sub-fields that indicate the one or more epoch parameters of the default epoch group and the assigned AID value.

In an example embodiment, the EP element 702 may include various fields such as element ID 704, length 706, element ID extension 708, group EDP epoch 710, and a control field 712. The element ID 704 field (occupying one octet, for example) may be a value or a code that uniquely identifies the EP element 702 and may enable a correct interpretation of the wireless frame 700 at the STA. The length 706 field (occupying one octet, for example) may specify the size of the EP element 702. The length 706 field may enable precise parsing of the contents of the EP element 702 at the STA. Following this, the element ID extension 708 field (occupying one octet, for example) may extend the identification capabilities of the EP element 702 by providing additional encoding information.

Further, the group EDP epoch 710 field may occupy, for example, either 0 or 12 octets and determine the anonymization mode applicable to the STA. The group EDP epoch 710 field may include multiple sub-fields, such as smallest anonymized AID 714, AID range 716, group epoch duration 718, next epoch 720, reserved 722, and current epoch number 724. The smallest anonymized AID 714 sub-field (occupying 11 bits, for example) may identify the minimum AID value eligible for periodic anonymization within the default epoch group. Thus, indicating the lower limit of the anonymized AID range to the STA. The AID range 716 sub-field (occupying 11 bits, for example) may indicate a count of AID values included in the anonymization scheme, effectively defining the span of the anonymized AID range associated with the AP or the BSS of the AP. The group epoch duration 718 sub-field (occupying 14 bits, for example) may specify a duration (e.g., timing information) of the default epoch group. In an example, three most significant bits (MSBs) may determine a number of Target Beacon Transmission Times (TBTTs), while the remaining 11 least significant bits (LSBs) may specify the duration of the epoch as per the indicated number of TBTTs. The next epoch 720 sub-field (occupying 11 bits, for example) may indicate the start time (e.g., the timing information) of the next EDP epoch of the default epoch group. In an example, the start time may be expressed in group epoch length unit 726, and also encoded in group epoch duration 728 of the next epoch. The current epoch number 724 (occupying 48 bits, for example) sub-field may identify an ongoing epoch interval of the default epoch to provide a reference point to the STA.

Further, the control field 712 (spanning 2 octets, for example) may include various sub-fields that regulate the operation of the group-based EDP. For example, the control field 712 may include a periodic anonymization activated 730 sub-field (spanning 1 bit, for example) that indicates whether periodic anonymization is enabled for the STA, ensuring dynamic MAC address rotation if active. The STA-specific setting 732 sub-field (spanning 1 bit, for example) may signal whether individual settings override group-level parameters, allowing fine-grained control for specific STAs. Further, the remaining bits of the control field 712 may be reserved 734 for future use or extensions, maintaining compatibility and flexibility for evolving standards.

Although a specific embodiment for a message format of a wireless frame transmitted by an AP to communicate one or more epoch parameters of a default epoch group to an STA suitable for carrying out the various steps, processes, methods, and operations described herein is discussed with respect to FIG. 7, any of a variety of systems and/or processes may be utilized in accordance with embodiments of the disclosure. For example, the AP in addition to the default epoch group may support additional epoch groups. Further, upon receiving the one or more epoch parameters of the default epoch group via an EP element in a wireless frame, the STA can choose to stay in the default epoch group, request to join a different epoch group, or request STA-specific epoch parameters for individual-based EDP. The elements depicted in FIG. 7 may also be interchangeable with other elements of FIGS. 1-6 and 8-19 as required to realize a particularly desired embodiment.

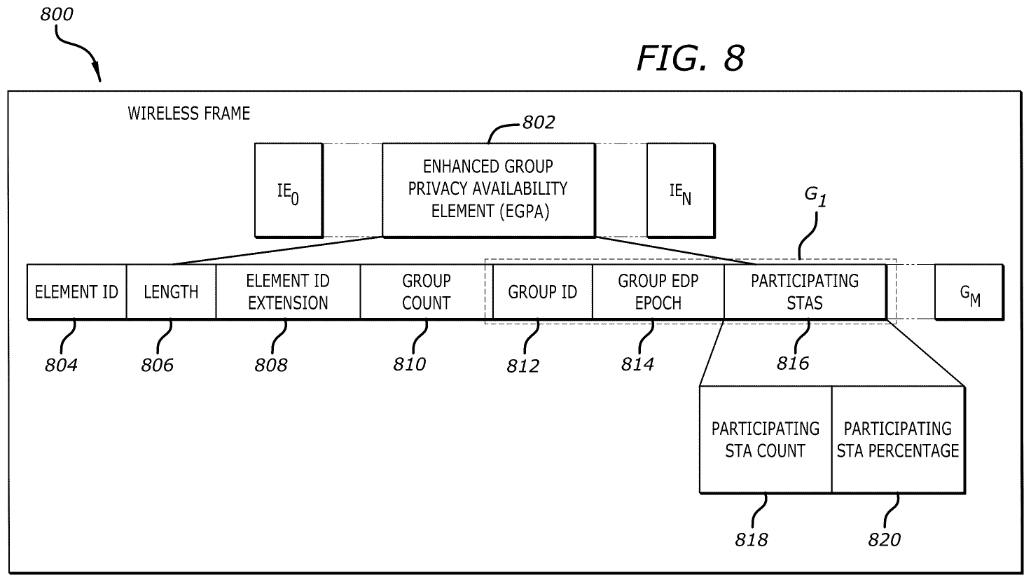

Referring to FIG. 8, a diagram that illustrates a message format of a wireless frame 800 transmitted by an AP to communicate one or more epoch parameters associated with a plurality of epoch groups to one or more STAs in accordance with various embodiments of the disclosure is shown.

In various embodiments, the one or more epoch parameters of the plurality of epoch groups may be transmitted in one or more information elements of the wireless frame 800. As shown in FIG. 8, the wireless frame 800 includes information elements IE₀-IE_{N}. In a scenario where the wireless frame 800 is transmitted to advertise the one or more epoch parameters of the plurality of epoch groups, the wireless frame 800 may also include a specialized information element, for example, an enhanced group privacy availability (EGPA) element 802. The EGPA element 802 may include a plurality of fields and sub-fields that indicate the one or more epoch parameters associated with the plurality of epoch groups.

In an example embodiment, the EGPA element 802 may include various fields such as element ID 804, length 806, element ID extension 808, group count 810, group ID 812, group EDP epoch 814, and participating STAs 816. The element ID 804 field (occupying one octet, for example) may be a value or a code that uniquely identifies the EGPA element 802 and may enable a correct interpretation of the wireless frame 800 at an STA. The length 806 field (occupying one octet, for example) may specify the size of the EGPA element 802. The length 806 field may enable precise parsing of the contents of the EGPA element 802 at the STA. Following this, the element ID extension 808 field (occupying one octet, for example) may extend the identification capabilities of the EGPA element 802 by providing additional encoding information. Further, the group count 810 field (occupying one octet, for example) may indicate a number of epoch groups in the plurality of epoch groups that are supported by the AP. The one or more epoch parameters of each epoch group may be included within a respective tuple including the group ID 812 field, the group EDP epoch 814 field, and the participating STAs 816 field. In other words, if the group count 810 field indicates “M” epoch groups (where ‘M’ is greater than equal to 1), the EGPA element 802 may include ‘M’ tuples (e.g., G₁-G_{M}) of the group ID 812 field, the group EDP epoch 814 field, and the participating STAs 816 field, one for each epoch group.

The group ID 812 field may occupy one octet for example, to indicate an identifier of a corresponding epoch group of the plurality of epoch groups. In an example, a group ID value ‘0’ may be reserved for a default epoch group and a group ID value ‘255’ may be reserved for signaling individual-based EDP. Remaining group ID values 1-254 may be assigned to uniquely identify each of the plurality of epoch groups.

Further, the group EDP epoch 814 field may occupy, for example, either 0 or 12 octets and may include epoch timing information associated with the corresponding epoch group. In an example, the group EDP epoch 814 field may include multiple sub-fields, such as smallest anonymized AID, AID range, group epoch duration, next epoch, reserved, and current epoch number as described in the foregoing description of FIG. 7, to indicate the epoch timing information of the corresponding epoch group.

Furthermore, the participating STAs 816 field may indicate a number of wireless STAs participating in a corresponding epoch group of the plurality of epoch groups. In more embodiments, the participating STAs 816 field may include a plurality of octets, for example, three octets. One or more first octets (for example, first two octets of the three octets) in the participating STAs 816 field may correspond to a participating STA count 818 sub-field, which may identify a number of wireless STAs participating in the corresponding epoch group. Further, one or more additional octets (for example, one remaining octet of the three octets) in the participating STAs 816 field may correspond to a participating STA percentage 820 sub-field, which may identify a percentage of associated wireless STAs participating in the corresponding epoch group. For example, a BSS may include 50 associated STAs, of which 10 STAs are participating in a first epoch group. In such a scenario, the participating STA count 818 sub-field for the first epoch group may identify ‘10’STAs and the participating STA percentage 820 sub-field for the first epoch group may identify ‘20%’. In other words, the EGPA element 802 may include reserved fields, such as the participating STAs 816 field, that includes the one or more first octets corresponding to the participating STA count 818 and the one or more additional octets corresponding to the participating STA percentage 820.

In further embodiments, the AP may transmit the wireless frame 800 to advertise the one or more epoch parameters of the plurality of epoch groups, for example, M epoch groups. The wireless frame 800 may be a beacon frame or a probe response frame. In many embodiments, the AP may transmit the wireless frame 800 periodically. In many further embodiments, the AP may transmit the wireless frame 800 to associated STAs that support group-based EDP, individual-based EDP, or both for advertising the one or more epoch parameters of the plurality of epoch groups. In many more embodiments, the AP may transmit the wireless frame 800 each time a new STA joins the BSS or is associated with the AP. For example, the AP may transmit, such as unicast, the wireless frame 800 to an STA after the STA is assigned to the default epoch group during 4-way handshake that is a part of the association process. In several embodiments, the AP may transmit (such as unicast or broadcast) the wireless frame 800 each time an epoch parameter of the one or more epoch parameters of any of the plurality of epoch groups changes. For example, initially the participating STAs 816 field for a first epoch group may identify ten wireless STAs in the participating STA count 818 subfield. As time progresses, one of the wireless STAs in the first epoch group may leave the first epoch group. In such a scenario, as the participating STAs 816 field associated with the first epoch group has changed, the AP may transmit the wireless frame 800 to advertise the latest one or more epoch parameters associated with the plurality of epoch groups.

Although a specific embodiment for a message format of a wireless frame transmitted by an AP to communicate one or more epoch parameters of a plurality of epoch groups to one or more STAs suitable for carrying out the various steps, processes, methods, and operations described herein is discussed with respect to FIG. 8, any of a variety of systems and/or processes may be utilized in accordance with embodiments of the disclosure. For example, upon transmitting the wireless frame 800 advertising the one or more epoch parameters associated with the plurality of epoch groups, the AP may receive a wireless action frame from a wireless STA indicating one of the plurality of epoch groups that the wireless STA requests to join. The elements depicted in FIG. 8 may also be interchangeable with other elements of FIGS. 1-7 and 9-19 as required to realize a particularly desired embodiment.

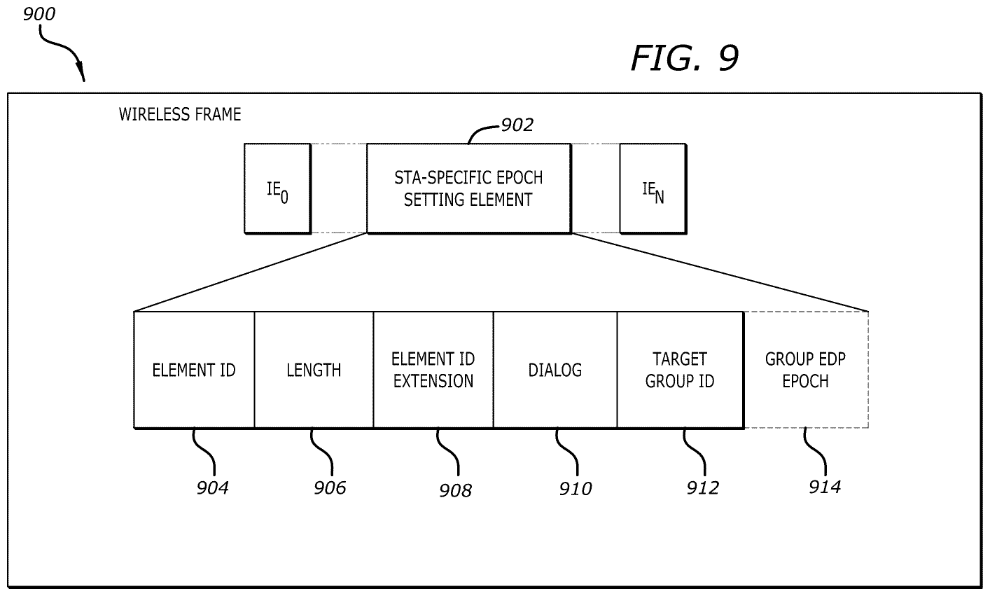

Referring to FIG. 9, a diagram that illustrates a message format of a wireless action frame 900 transmitted by a wireless device supporting EDP in accordance with various embodiments of the disclosure is shown. In many embodiments, the wireless action frame 900 may be transmitted by a wireless STA (also referred to as “STA”). The STA may transmit the wireless action frame 900 to an associated AP to request STA-specific epoch settings. In many examples, the STA upon association may be assigned to a default epoch group by the AP. However, the STA may want to join another epoch group, participate in individual-based EDP, or opt out of EDP. In such embodiments, the wireless STA may transmit the wireless action frame 900 to the AP as a request for a particular EDP action. In further examples, the wireless STA currently participating in a first epoch group may want to leave the first epoch group. In such embodiments, the wireless STA may transmit the wireless action frame 900 to the AP as an indication to leave or not participate in the first epoch group. In more examples, the wireless STA may transmit the wireless action frame 900 to the AP to reject epoch group assignment by the AP. In yet more examples, the wireless STA may transmit the wireless action frame 900 to the AP to reject participation in group-based EDP or reject participation in any of a plurality of epoch groups associated with the AP. In still more examples, the wireless STA may request to participate in individual-based EDP by transmitting the wireless action frame 900.

In further embodiments, the wireless action frame 900 can also be transmitted by an AP to a wireless STA. The AP may transmit the wireless action frame 900 to the STA as a response to a request from the STA. For example, the STA may have requested the AP to join a particular epoch group, leave a particular epoch group, not participate in group-based EDP, participate in individual-based EDP, or the like. In such embodiments, the AP may transmit the wireless action frame 900 to the STA to indicate an acceptance or rejection of the request of the STA.

In various embodiments, the wireless action frame 900 may include one or more information elements. As shown in FIG. 9, the wireless action frame 900 includes information elements IE₀-IE_{N}. The wireless action frame 900 may also include a specialized information element, for example, an STA-specific epoch setting element 902. The STA-specific epoch setting element 902 may include a plurality of fields and sub-fields. For example, the STA-specific epoch setting element 902 may include various fields such as element ID 904, length 906, element ID extension 908, dialog 910, group target ID 912, and group EDP epoch 914.

In a number of embodiments, the element ID 904 field (occupying one octet, for example) may be a value or a code that uniquely identifies the STA-specific epoch setting element 902 and may enable a correct interpretation of the wireless action frame 900. The length 906 field (occupying one octet, for example) may specify the size of the STA-specific epoch setting element 902. The length 906 field may enable precise parsing of the contents of the STA-specific epoch setting element 902. Following this, the element ID extension 908 field (occupying one octet, for example) may extend the identification capabilities of the STA-specific epoch setting element 902 by providing additional encoding information.

Further, the dialog 910 field (occupying one octet, for example) may indicate a status of a request or a response indicated by the wireless action frame 900. The dialog 910 field can have one of a plurality of values, each corresponding to different states, actions, or context. Examples of the plurality of values may include ‘0, ‘1’, ‘2’, ‘3’, ‘4’, ‘5’, or the like.

In an example scenario, a first value ‘0’ may be reserved for accommodating future enhancements in the wireless action frame 900. The dialog 910 field having a second value ‘1’ may indicate that the wireless action frame 900 is a request from an STA to either join a particular epoch group or initiate individual-based EDP. Further, the dialog 910 field having a third value ‘2’ may indicate that the wireless action frame 900 is a response from an AP accepting a request of an STA, while the dialog 910 field having a fourth value ‘3’ may indicate that the wireless action frame 900 is a response from an AP rejecting a request of an STA. Further, the dialog 910 field having a fifth value ‘4’ may indicate that the wireless action frame 900 is a request from an STA to abstain from participation in any epoch group or group-based EDP. Furthermore, the dialog 910 field having a sixth value ‘5’ may indicate that the wireless action frame 900 is a request from an STA to either leave a specific epoch group or cancel a previously initiated individual-based EDP.

The group target ID 912 field (occupying one octet, for example) may identify the particular epoch group the STA is requesting to join or leave. For example, if the dialog 910 field has the second value ‘1’ and the group target ID 912 field includes a group ID ‘255’, it may indicate that an STA is not requesting to join any epoch group but rather is requesting STA-specific parameters for individual-based EDP. In further examples, if the dialog 910 field has the second value ‘1’ and the group target ID 912 field includes a group ID in the range of 0-254, it may indicate that the STA is requesting to join a particular epoch group having the indicated group ID. In many further examples, if the dialog 910 field has the sixth value ‘5’ and the group target ID 912 field includes a group ID in the range of 0-254, it may indicate that the STA is requesting to leave a particular epoch group having the indicated group ID. In additional examples, if the dialog 910 field has the sixth value ‘5’ and the group target ID 912 field includes the group ID 255, it may indicate that the STA is requesting to cancel a previously initiated individual-based EDP. In numerous examples, if the dialog 910 field has the fifth value ‘4’ and the group target ID 912 field includes one or more reserved values, it may indicate that the STA is requesting to not participate in group-based EDP. In several examples, if the dialog 910 field has the third value ‘2’ and the group target ID 912 field includes a group ID in the range of 0-255, it may indicate that the AP is accepting a request of the STA to join a particular epoch group or participate in individual-based EDP. Further, if the dialog 910 field has the fourth value ‘3’ and the group target ID 912 field includes the one or more reserved values, it may indicate that the AP is rejecting a request of the STA.

The group EDP epoch 914 field may be an optional field in the STA-specific epoch setting element 902. The presence or absence of the group EDP epoch 914 field may depend on the context indicated by the dialog 910 and the group target ID 912 fields. For example, when the dialog 910 field has the second value ‘1’ and the group target ID 912 field has a group ID in the range of 0-254, the group EDP epoch 914 field may be absent from the STA-specific epoch setting element 902. However, if the dialog 910 field has the second value ‘1’ and the group target ID 912 field has a group ID 255, the group EDP epoch 914 field may be present in the STA-specific epoch setting element 902. Further, if the dialog 910 field has the third value ‘2’, the group EDP epoch 914 field may be present in the STA-specific epoch setting element 902. Furthermore, if the dialog 910 field has the values ‘3’, ‘4’, or ‘5’, the group EDP epoch 914 field may be absent.

In an example, the group EDP epoch 914 field, when present in the STA-specific epoch setting element 902, may include multiple sub-fields, such as smallest anonymized AID, AID range, group epoch duration, next epoch, reserved, and current epoch number as described in the foregoing description of FIG. 7, to indicate epoch timing information of a corresponding epoch group as indicated by the context of the dialog 910 and the group target ID 912 fields.

Although a specific embodiment for a message format of a wireless action frame 900 transmitted by a wireless device supporting EDP suitable for carrying out the various steps, processes, methods, and operations described herein is discussed with respect to FIG. 9, any of a variety of systems and/or processes may be utilized in accordance with embodiments of the disclosure. For example, the wireless action frame 900 may be transmitted by the STA based on receiving one or more epoch parameters associated with a plurality of groups from the AP. Further, the wireless action frame 900 may be transmitted by the AP in response to another wireless action frame 900 transmitted by the STA to the AP. The elements depicted in FIG. 9 may also be interchangeable with other elements of FIGS. 1-8 and 10-19 as required to realize a particularly desired embodiment.

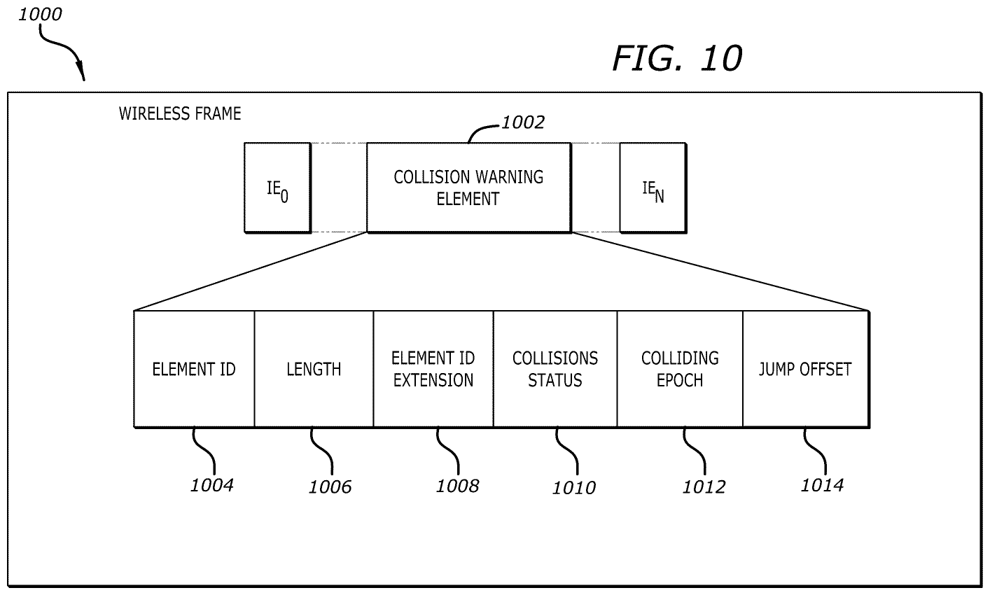

Referring to FIG. 10, a diagram that illustrates a message format of a wireless frame 1000 transmitted by a wireless device participating in group-based EDP or individual-based EDP in accordance with various embodiments of the disclosure is shown. In many embodiments, the wireless frame 1000 may be transmitted by an AP to an STA participating in group-based EDP or individual-based EDP as a MAC collision warning. In an example, the wireless frame 1000 may be a wireless action frame. The AP may be associated with a plurality of STAs participating in group-based EDP or individual-based EDP. The AP may be configured to identify an OTA MAC address that a first STA of the plurality of STAs is likely to utilize in an upcoming epoch interval (or forthcoming epoch, a future epoch) associated with group-based EDP or individual-based EDP. The AP may further determine whether the OTA MAC address that the first STA may utilize in the upcoming epoch interval is likely to cause a collision with an OTA MAC address of a second STA of the plurality of STAs. In other words, the AP may determine whether the identified OTA MAC address of the first STA is same as the OTA MAC address identified for the second STA for the upcoming epoch interval. Upon determining that the OTA MAC address of the first STA may cause a collision with the OTA MAC address of the second STA in the upcoming epoch interval, the AP may transmit to the first STA, the wireless frame 1000 as the MAC collision warning. The wireless frame 1000 may instruct the first STA to skip the use of the OTA MAC address designated for the upcoming epoch interval, and use an alternate OTA MAC address, for example, an OTA MAC address designated for a subsequent epoch interval after the upcoming epoch interval. In an example, the wireless frame 1000 may further indicate the upcoming epoch interval in which collision is determined and the subsequent epoch interval to the first STA.

In a number of embodiments, the wireless frame 1000 may be transmitted by an STA to an AP as a response to the MAC collision warning. For example, upon receiving the wireless frame 1000 from the AP, the first STA may also transmit another wireless frame 1000 to the AP to acknowledge or reject the MAC collision warning of the AP.

In various embodiments, the wireless frame 1000 may include one or more information elements. As shown in FIG. 10, the wireless frame 1000 includes information elements IE₀-IE_{N}. The wireless frame 1000 may also include a specialized information element, for example, a collision warning element 1002. The collision warning element 1002 may include a plurality of fields and sub-fields to provide the collision warning to the first STA. For example, the collision warning element 1002 may include various fields such as element ID 1004, length 1006, element ID extension 1008, collision status 1010, colliding epoch 1012, and jump offset 1014.

In a number of embodiments, the element ID 1004 field (occupying one octet, for example) may be a value or a code that uniquely identifies the collision warning element 1002 to the first STA and may enable a correct interpretation of the wireless frame 1000. For example, the element ID 1004 field may indicate a type of frame, signaling that the wireless frame 1000 may be related to collision or epoch adjustments. The length 1006 field (occupying one octet, for example) may specify the size of the collision warning element 1002. The length 1006 field may enable precise parsing of the contents of the collision warning element 1002 at the first STA. Following this, the element ID extension 1008 field (occupying one octet, for example) may extend the identification capabilities of the collision warning element 1002 by providing additional encoding information.

Further, the collision status 1010 field (occupying one octet, for example) may indicate an intent of the wireless frame 1000. For example, the AP sets may set the collision status 1010 field ‘1’ to indicate a potential MAC collision in a future epoch (e.g., the upcoming epoch). When responding, the first STA may set the collision status 1010 field to ‘0’ to acknowledge the collision warning and agree to skip the use of the designated OTA MAC address in the future epoch, or to ‘2’ to reject the collision warning and undergo address rotation in the future epoch using the designated OTA MAC address.

Additionally, the colliding epoch 1012 field (occupying one octet, for example) may indicate the future epoch where the collision is determined by the AP. In other words, the colliding epoch 1012 field may indicate a specific epoch interval number where two or more STAs may inadvertently use the same anonymized OTA MAC address or other parameters. In an example, the future epoch ‘n’ may be specified or indicated in units of epochs, with a value of ‘m’ indicating the current epoch interval. Further, the jump offset 1014 field may indicate how many epochs the first STA must skip to avoid the collision. For example, if the current epoch is ‘m’ and a collision is likely to occur at an epoch interval ‘n’ (as indicated by the colliding epoch 1012 field), the collision warning element 1002 may instruct the first STA to use an OTA MAC address designated for a subsequent future epoch interval ‘m+n+o’. Here, ‘o’ may be an offset value specified in the jump offset 1014 field. For example, the wireless frame 1000 transmitted by the AP may indicate the first STA to skip epoch 556 parameters, and jump to epoch 558 parameters for anonymization.

Although a specific embodiment for a message format of a wireless frame 1000 transmitted by a wireless device participating in group-based EDP or individual-based EDP suitable for carrying out the various steps, processes, methods, and operations described herein is discussed with respect to FIG. 10, any of a variety of systems and/or processes may be utilized in accordance with embodiments of the disclosure. For example, if the first STA accepts the collision warning, the first STA may use an OTA MAC address designated for the subsequent epoch interval m+n+o during the upcoming epoch interval ‘n’. The elements depicted in FIG. 10 may also be interchangeable with other elements of FIGS. 1-9 and 11-19 as required to realize a particularly desired embodiment.

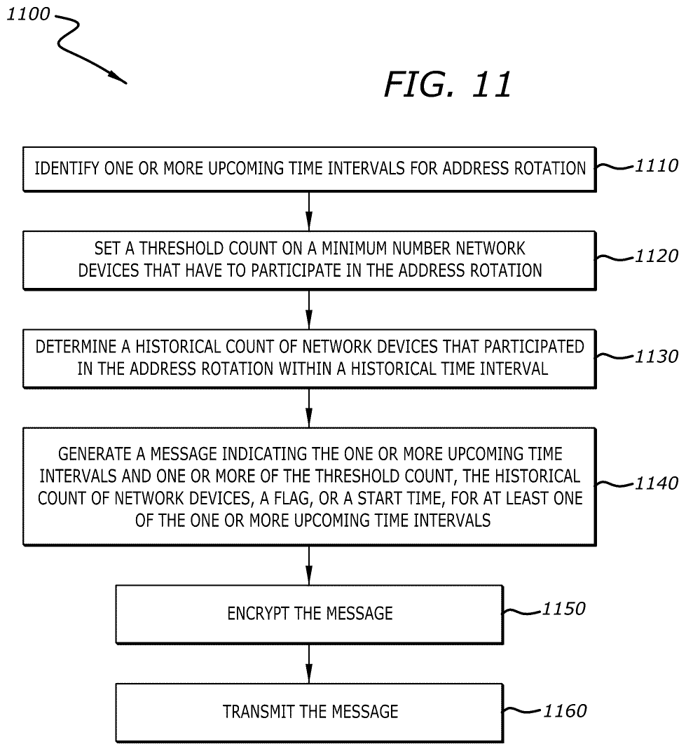

Referring to FIG. 11, a flowchart depicting a process 1100 for transmitting a wireless frame for coordinating device address rotation in accordance with various embodiments of the disclosure is shown. In many embodiments, the process 1100 may identify one or more upcoming time intervals for address rotation (block 1110). The one or more upcoming time intervals may include time schedules or timing information at which a plurality of network devices (interchangeably referred to as “STAs” or “stations”) connected to a network can opt to undergo a coordinated address rotation. In an example, the process 1100 can be performed by an AP communicatively coupled to the plurality of stations. The one or more upcoming time intervals may include, for example, epoch boundaries at which address rotation can happen. The plurality of stations may select any of the one or more upcoming time intervals for performing address rotation, for example, OTA MAC address rotation, Internet Protocol (IP) address rotation, or any other suitable identifier rotation. Examples of the plurality of stations may include, but are not limited to, smartphones, laptops, tablets, smartwatches, smart appliances, wearable devices, IoT devices, or the like. In an example, the one or more upcoming time intervals may correspond to periodic epochs associated with a plurality of epoch groups.

In a number of embodiments, the process 1100 may set a threshold count on a minimum number of network devices that have to participate in the address rotation (block 1120). In various embodiments, the threshold count may refer to a crowd obfuscation parameter that is required to provide increased entropy during address rotation to enhance privacy and security. Such a crowd obfuscation parameter may prevent eavesdroppers monitoring the network to track down stations undergoing address rotation. In various embodiments, the threshold count may correspond to a minimum number of network devices that can form an epoch group for group-based EDP.

In a variety of embodiments, the process 1100 may determine a historical count of network devices that participated in the address rotation within a historical time interval (block 1130). In numerous embodiments, the historical time interval may be prior to the identified one or more upcoming time intervals. For example, some stations may have opted to participate in address rotation at the historical time interval but failed to change their addresses at the historical time interval, while other stations may not have opted but still rotated their address at the historical time interval. Such determination may be required to determine an actual count of network devices that changed their addresses within the historical time interval.

In more embodiments, the process 1100 may generate a message indicating the one or more upcoming time intervals and one or more of the threshold counts associated with the one or more upcoming time intervals, the historical count of network devices, a flag, or a start time for at least one of the one or more upcoming time intervals (block 1140). The flag may be included in the message to indicate whether a threshold count set for the historical time interval was reached or not. For example, if the threshold count set for the historical time interval was ‘10’ and the historical count of network devices that rotated (e.g., changed) their addresses was ‘12’, the flag can have a first value indicating that threshold count was reached (e.g., satisfied) in the historical time interval. However, if only ‘8’ network devices changed their address at the historical time interval, the flag can have a second value indicating that the threshold count was not reached (e.g., satisfied) in the historical time interval. By indicating, in the message, whether the threshold count was reached in the historical time interval, the process 1100 may indirectly indicate a likelihood of the threshold count being satisfied within an upcoming time interval as well. By disseminating this comprehensive information in the message, the process 1100 may enable the stations to choose an upcoming time interval, or a suitable epoch group, for address rotation that can provide the best crowd obfuscation parameter and satisfy the requirements of the stations. In an example, the one or more upcoming time intervals, the one or more of the threshold counts associated with the one or more upcoming time intervals, the historical count of network devices, the flag, or the start time for at least one of the one or more upcoming time intervals may correspond to one or more epoch parameters associated with the plurality of epoch groups. Further, the message may be a wireless frame, where the one or more epoch parameters are indicated in one or more information elements of the wireless frame.

In additional embodiments, the process 1100 may encrypt the message (block 1150). Encrypting the message before transmitting may ensure that only stations connected to the network can access the message, protecting the stations from eavesdroppers monitoring the network. The encryption process may use a secure encryption algorithm to encode the message, making it unreadable by any station that does not have a decryption key associated with the encryption algorithm. As a result, only stations connected to the network can decrypt and read the message, ensuring that sensitive information remains confidential and secure, thereby enhancing the overall integrity and privacy of the address rotation of the stations.

In further embodiments, the process 1100 may transmit the message (block 1160). In several embodiments, the message can be transmitted at specific time periods. The specific time periods can be periodic time intervals or random time intervals. By transmitting the message at specific time periods, the process 1100 may ensure that the connected stations are informed and prepared for an upcoming address rotation in an upcoming time interval of the one or more upcoming time intervals. The message can be transmitted via a management frame, an announcement frame, a beacon, or the like. Further, the message can be transmitted by broadcasting or unicasting.

Although a specific embodiment for transmitting a wireless frame for coordinating device address rotation suitable for carrying out the various steps, processes, methods, and operations described herein is discussed with respect to FIG. 11, any of a variety of systems and/or processes may be utilized in accordance with embodiments of the disclosure. For example, in numerous additional embodiments, the process 1100 can control a frequency of re-transmitting the message based on whether the threshold count is satisfied or not for the earliest upcoming time interval. The elements depicted in FIG. 11 may also be interchangeable with other elements of FIGS. 1-10 and 12-19 as required to realize a particularly desired embodiment.

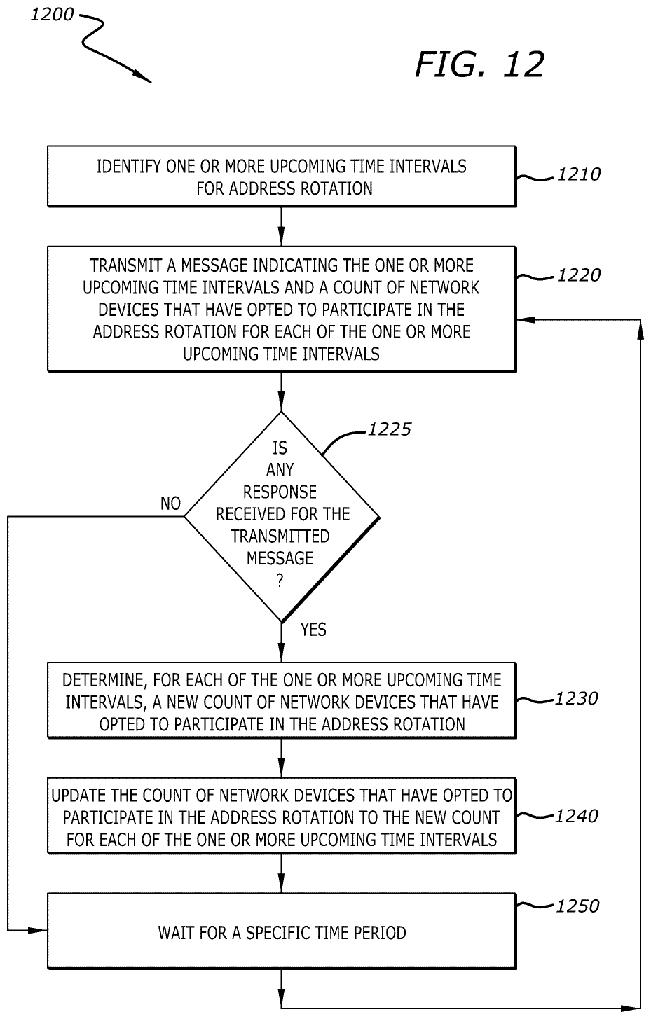

Referring to FIG. 12, a flowchart depicting a process 1200 for transmitting a message for coordinating device address rotation in accordance with various embodiments of the disclosure is shown. In many embodiments, the process 1200 may identify one or more upcoming time intervals for address rotation (block 1210). The one or more upcoming time intervals may refer to specific future time intervals during which address rotation of a plurality of network devices (interchangeably referred to as “STAs”) can occur. The plurality of network devices may belong to one or more epoch groups. This involves determining precise time instances at which a group of stations (e.g., an epoch group) can change or rotate their MAC addresses at the same time to enhance network privacy and security. For example, the one or more upcoming time intervals may be scheduled every hour at the 30-minute mark (e.g., ‘1:30 PM’, ‘2:30 PM’, ‘3:30 PM’, . . . , and ‘12:30 AM’). In further examples, the process 1200 may identify only one upcoming time interval at a time. In a scenario where there are multiple epoch groups, the process 1200 may identify corresponding one or more upcoming time intervals for each epoch group. In other words, the one or more upcoming time intervals identified for a first epoch group may be different from the one or more upcoming time intervals identified for a second epoch group.

In a number of embodiments, the process 1200 may transmit a message indicating the one or more upcoming time intervals and a count of network devices that have opted to participate in the address rotation for each of the one or more upcoming time intervals (block 1220). The message may be transmitted to all stations connected to the AP, informing the stations of the identified upcoming time intervals for the address rotation and the count of other stations that have selected to change their addresses at those upcoming time intervals. Thus, enabling the stations to select an upcoming time interval to change their addresses in co-ordination with other stations that have selected the same upcoming time interval. Including the count of network devices that have already opted to participate in the address rotation for each of the one or more upcoming time intervals may enable a station to decide whether to join the address rotation based on the count of participating peers. In a non-limiting example, the message may indicate that address rotations for a first epoch group will occur at ‘1:30 PM’, ‘2:30 PM’, and ‘3:30 PM’. The message may further indicate that ‘5’ stations have already opted to participate in the first epoch group for address rotation at ‘1:30 PM’, ‘3’ stations for ‘2:30 PM’ rotation, and ‘7’ stations for ‘3:30 PM’. In other words, by transmitting the message, the process 1200 transmits one or more epoch parameters associated with one or more epoch groups. The one or more upcoming time intervals, indicating timing information, may correspond to a first epoch parameter and the count of network devices may correspond to a second epoch parameter. Likewise, the message can indicate various additional epoch parameters also.

In more embodiments, the process 1200 may determine whether any response is received for the transmitted message (block 1225). In a variety of embodiments, the process 1200 may receive a response from at least one STA. The response may refer to a wireless action frame that indicates whether the at least one wireless station (also referred to as “station” or “STA”) intends to participate in the address rotation within any of the one or more upcoming time intervals. In many examples, the at least one station can send a response to participate in the address rotation within any of the one or more upcoming time intervals. In further examples, the at least one station can also send a response to opt out of participating in the address rotation in the one or more upcoming time intervals. For example, a ‘Device A’ transmits a response with an intention to participate in ‘1:30 PM’ address rotation, while another ‘Device B’ transmits a response with an intention to join the ‘2:30 PM’ address rotation. Further, a ‘Device C’ may transmit a response with an intention to not participate in the ‘3:30 PM’ address rotation.

If at least one response is received, in additional embodiments, the process 1200 may determine, for each of the one or more upcoming time intervals, a new count of network devices that have opted to participate in the address rotation (block 1230). In yet more embodiments, the process 1200 may determine whether the response indicates an intent to participate in the address rotation or an intent to be released from an epoch group. epoch group may correspond to a group of stations that have opted in to participate in address rotation within a specific upcoming time interval. Further, the new count may be determined for each of the one or more upcoming time intervals based on whether the response indicates an intent to participate in the address rotation or an intent to be released from an address rotation pool. For example, based on the response of ‘Device A’ indicating an intent to participate in the ‘1:30 PM’ address rotation, the device count for the ‘1:30 PM’ address rotation is increased from ‘5’ to ‘6’. Likewise, based on the response of ‘Device B’ indicating an intent to participate in the ‘2:30 PM’ address rotation, the device count for the ‘2:30 PM’ address rotation is increased from ‘3’ to ‘4’. However, if the ‘Device C’ had initially opted in to participate in the ‘3:30 PM’ address rotation and later withdrew from the address rotation pool by transmitting the response to the transmitted message, the device count for the ‘3:30 PM’ address rotation may now be reduced from ‘7’ to ‘6’.

In further embodiments, the process 1200 may update the count of network devices that have opted to participate in the address rotation to the new count for each of the one or more upcoming time intervals (block 1240). In other words, the count of the network devices that have opted to participate in the address rotation is updated to reflect the new count of network devices. For example, the device count for the ‘1:30 PM’ address rotation is updated to ‘6’ devices, the device count for the ‘2:30 PM’ address rotation is updated to ‘4’ devices, and the device count for the ‘3:30 PM’ address rotation is updated to ‘6’ devices, in the message.

In still more embodiments the process 1200 may wait for a specific time period (block 1250). In other words, the process 1200 may wait for the specific time period set for re-transmitting the message. The waiting period may allow additional time for more stations to decide on their participation in address rotation. For example, the process 1200 may wait for ‘15’ minutes to allow more stations to decide and respond to the transmitted message. After the specific time period is over, the process 1200 may transmit an updated message with the new count of network devices. In still additional embodiments, if no response is received for the transmitted message, the process 1200 may wait for the specific time period before re-transmitting the message (block 1250).

Although a specific embodiment for transmitting a message for coordinating device address rotation suitable for carrying out the various steps, processes, methods, and operations described herein is discussed with respect to FIG. 12, any of a variety of systems and/or processes may be utilized in accordance with embodiments of the disclosure. For example, in several more embodiments, the process 1200 may receive encrypted responses from stations. The elements depicted in FIG. 12 may also be interchangeable with other elements of FIGS. 1-11 and 13-19 as required to realize a particularly desired embodiment.

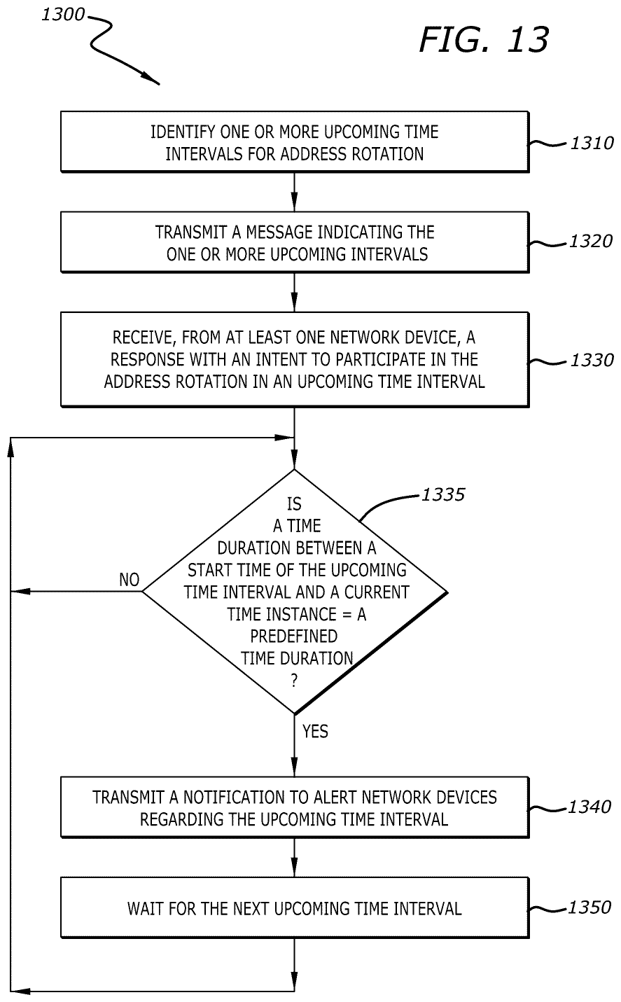

Referring to FIG. 13, a flowchart depicting a process 1300 for facilitating device address rotation in accordance with various embodiments of the disclosure is shown. In many embodiments, the process 1300 may identify one or more upcoming time intervals for address rotation (block 1310). The one or more upcoming time intervals may include time schedules at which a plurality of network devices (interchangeably referred to as “STAs”) connected to an AP can opt to undergo a coordinated address rotation. In an example, the process 1300 can be performed by an AP communicatively coupled to the plurality of stations. The plurality of network devices may belong to one or more epoch groups. The one or more upcoming time intervals may include, for example, epoch boundaries at which address rotation can happen. The plurality of stations may select any of the one or more upcoming time intervals for performing address rotation, for example, MAC address rotation, IP address rotation, or any other suitable identifier rotation. Examples of the plurality of stations may include, but are not limited to, smartphones, laptops, tablets, smartwatches, smart appliances, wearable devices, IoT devices, or the like. In a non-limiting example, the message may indicate that address rotations will occur at upcoming time intervals ‘1:30 PM’, ‘2:30 PM’, and ‘3:30 PM’.

In a number of embodiments, the process 1300 may transmit a message indicating the one or more upcoming time intervals (block 1320). The message can be transmitted via a wireless frame, for example, a management frame, an announcement frame, a beacon frame, a probe response frame, or the like. The message may be transmitted to notify the plurality of stations about future time schedules for address rotation (for example, MAC address rotation). For example, a wireless station connected to the network, upon receiving transmitted message, may decide to perform address rotation within any of the upcoming time intervals ‘1:30 PM’, ‘2:30 PM’, or ‘3:30 PM’ or continue with previously initiated group-based EDP or individual-based EDP.

In a variety of embodiments, the process 1300 may receive, from at least one network device (e.g., STA) a response with an intent to participate in the address rotation in an upcoming time interval of the one or more upcoming time intervals (block 1330). In other words, the at least one station may transmit a response for participating in the address rotation within the upcoming time interval. For example, a ‘Device A’ may respond with an intention to participate in ‘1:30 PM’ address rotation, while another ‘Device B’ may respond with an intention to join ‘2:30 PM’ address rotation.

In more embodiments, the process 1300 may determine whether a time duration between a start time of the upcoming time interval and a current time instance is equal to a predefined time duration (block 1335). The process 1300 may perform this check to ensure that stations in the network receive a timely reminder about the upcoming address rotation. The process 1300 may monitor the current time and compare it with the start time of the upcoming time interval. For example, the predefined time duration may be set to ‘10’ minutes. Thus, if the upcoming time interval is scheduled for ‘2:30 PM’, the process 1300 may determine whether the current time is ‘10’ minutes to ‘2:30 PM’ (i.e., ‘2:20 PM’). At ‘2 PM’, the condition may not be satisfied as it is still ‘30’ minutes to ‘2:30 PM’. Again at ‘2:10 PM’, the condition may not be met. However, when the current time instance is ‘2:20 PM’, the process 1300 may determine that the predefined time duration condition is satisfied.

If the time duration between the start time of the upcoming time interval and the current time instance is not equal to the predefined time duration, the process 1300 may continue to monitor the current time instance until the predefined time duration condition is satisfied (block 1335). However, if the time duration between the start time of the upcoming time interval and the current time instance is equal to the predefined time duration, in further embodiments, the process 1300 may transmit a notification to alert network devices regarding the upcoming time interval (block 1340). In other words, if the predefined time duration condition is satisfied, the process 1300 may transmit the notification to alert the stations about the address rotation at ‘2:30 PM’. This may ensure that the stations are adequately reminded and can prepare for an upcoming address rotation event.

In still more embodiments the process 1300 may wait for the next upcoming time interval (block 1350). For example, after the ‘2:30 PM’ time interval, the process 1300 may start checking for the next upcoming time interval, e.g., ‘3:30 PM’, and repeat the process of determining if the time duration between the start time of the upcoming time interval and the current time instance is equal to the predefined time duration. That is to say, the process 1300 may check whether the current time is exactly ‘10’ minutes to ‘3:30 PM’, i.e., ‘3:20 PM’.

Although a specific embodiment for facilitating device address rotation suitable for carrying out the various steps, processes, methods, and operations described herein is discussed with respect to FIG. 13, any of a variety of systems and/or processes may be utilized in accordance with embodiments of the disclosure. For example, in further additional embodiments, instead of transmitting the notification, the process 1300 may transmit the notification to only those stations that have opted to participate in the address rotation within the upcoming time interval. The elements depicted in FIG. 13 may also be interchangeable with other elements of FIGS. 1-12 and 14-19 as required to realize a particularly desired embodiment.

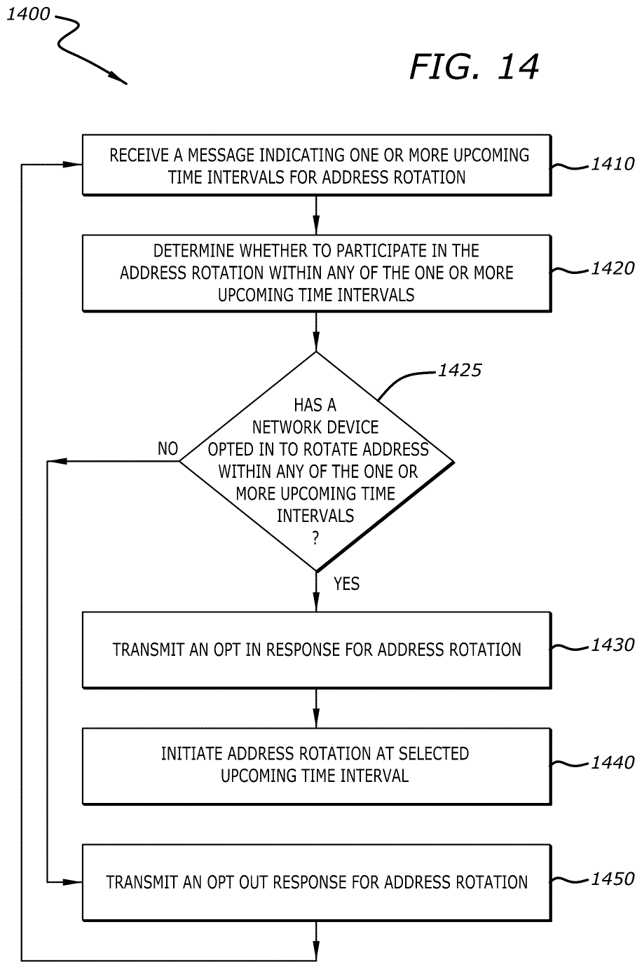

Referring to FIG. 14, a flowchart depicting a process 1400 for address rotation in a device that supports EDP in accordance with various embodiments of the disclosure is shown. The process 1400 may be performed by a network device (e.g., a wireless station “STA”) connected to a network. In many embodiments, the process 1400 may receive a message indicating one or more upcoming time intervals for address rotation (block 1410). In numerous embodiments, the message may have been transmitted by an AP to indicate the one or more upcoming time intervals scheduled for the address rotation, for example, MAC rotation. In other words, the message may indicate various details regarding the next address rotation events associated with one or more epoch groups. Examples of the wireless station may include, but are not limited to, smartphones, laptops, tablets, smartwatches, smart appliances, wearable devices, IoT devices, or the like. In a non-limiting example, the station (e.g., a laptop) connected to the network may receive a message from the AP stating that the next address rotations will occur at ‘1:30 PM’, ‘2:30 PM’, and ‘3:30 PM’.

In a number of embodiments, the process 1400 may determine whether to participate in the address rotation within any of the one or more upcoming time intervals (block 1420). Upon receiving the message, the station may assess whether the station should participate in the address rotation in any of the upcoming time intervals. This decision might be based on internal policies, current activity levels, or user settings of the STA. For example, the laptop may evaluate its current status, such as but not limited to whether the laptop is actively transferring data or is idle, whether any privacy feature requires MAC address change, or the like, and determine if address rotation is required within any of the one or more upcoming time intervals indicated by the received message. In further embodiments, if it is determined that address rotation is required, the process 1400 may be configured to select an upcoming time interval from the one or more upcoming time intervals based on a count of network devices that have opted for address rotation within the upcoming time interval. In other words, the station may have set its criteria for how many other stations need to be involved in the address rotation for the station to participate in group-based EDP. For example, in the received message, the upcoming time interval that is indicated to have the maximum count of network devices participating in the address rotation may be selected as the upcoming time interval for address rotation by the process 1400. In other words, based on the received message, the process 1400 may determine whether to join a new epoch group, continue with previously initiated group-based EDP, or individual-based EDP.

In a variety of embodiments, the process 1400 may determine whether the network device has opted to change address within any of the one or more upcoming time intervals (block 1425). In other words, the process 1400 may perform a check to determine whether the station has decided to participate in the address rotation at any of the one or more upcoming time intervals indicated by the received message.

If the station has opted to change its address within any of the one or more upcoming time intervals, in more embodiments, the process 1400 may transmit an opt in response for address rotation (block 1430). In numerous additional embodiments, the process 1400 may unicast the response to the AP that had transmitted the message. For example, the transmitted message may include an identifier of the AP. The process 1400 may identify the AP based on the identifier and accordingly unicast the response to the AP. In further additional embodiments, the process 1400 may transmit the response. In order to maintain privacy and security during transmit, the process 1400 may encrypt the response prior to transmitting. The response may be configured to indicate that the station will rotate its MAC address at one of the upcoming time intervals. The station may transmit the response via an opt in wireless action frame. For example, the laptop may transmit a response to the AP confirming its participation in the address rotation scheduled for ‘1:30 PM’. In several embodiments, the response may include a current MAC address or another unique identifier of the station along with the selected upcoming time interval, for example, ‘1:30 PM’.

In still more embodiments, the process 1400 may initiate address rotation at the selected upcoming time interval (block 1440). In other words, when the selected time interval arrives, the station may change its MAC address as planned. This MAC address randomization may depend on the type of the station as well as the type of network. Such MAC address rotation may ensure that the identity of the station is periodically refreshed, enhancing privacy. For example, at ‘1:30 PM’, the laptop changes its MAC address to a new MAC address, ensuring that network activities of the station are less traceable.

If the network device does not opt to rotate its address within any of the one or more upcoming time intervals, in additional embodiments, the process 1400 may transmit an opt out response for address rotation (block 1450). This indicates that the station will not be changing its MAC address within the upcoming time intervals and may decide to wait for the next message from the AP regarding future time intervals. The station may transmit the response to the AP via an opt out wireless action frame. For example, the laptop may transmit an opt out response to the AP indicating that the laptop will not participate in any of the upcoming address rotations indicated by the message transmitted by the AP. In several additional embodiments, the process 1400 may transmit the opt out response to withdraw or be released from an epoch group, the process 1400 had previously joined.

Although a specific embodiment for address rotation suitable for carrying out the various steps, processes, methods, and operations described herein is discussed with respect to FIG. 14, any of a variety of systems and/or processes may be utilized in accordance with embodiments of the disclosure. For example, the process 1400 can initiate address rotation in any of the upcoming time intervals indicated by the message even if the station had transmitted an opt out response previously. In still further embodiments, the process 1400 may perform the address rotation earlier than the prescribed upcoming time interval. In such a scenario, the process 1400 may transmit a response frame to the AP that had transmitted the message for address rotation. The response frame may include an announce bit configured to indicate that the address (e.g., MAC address) of the station is rotated prior to the prescribed or selected upcoming time interval by a predefined time. The elements depicted in FIG. 14 may also be interchangeable with other elements of FIGS. 1-13 and 15-19 as required to realize a particularly desired embodiment.

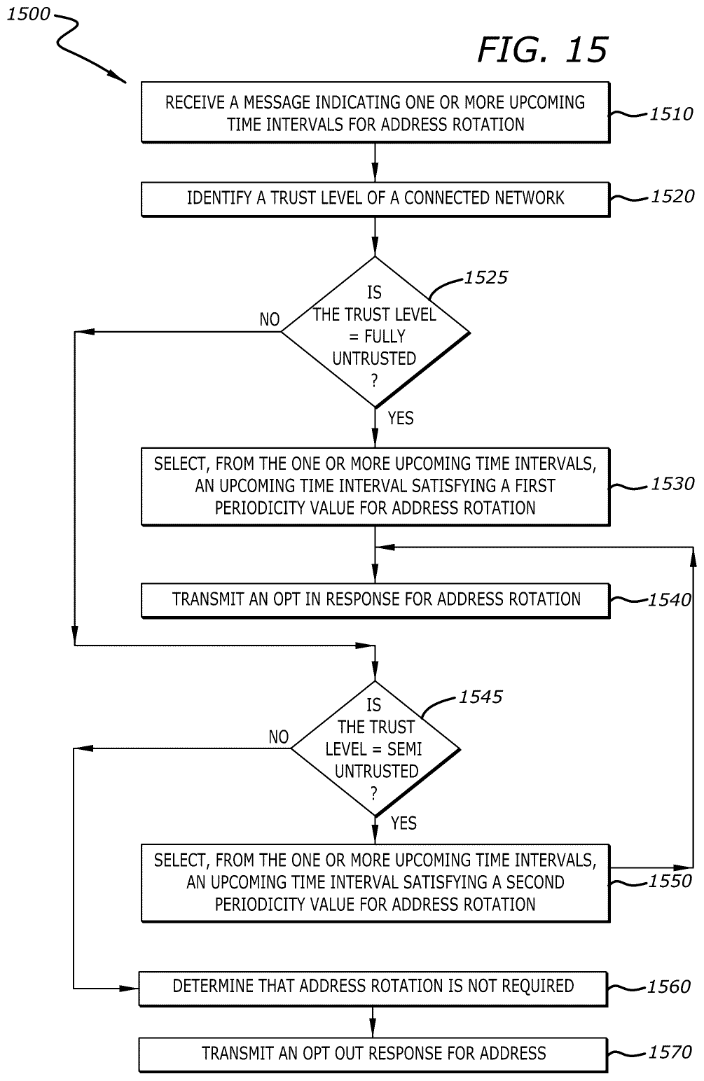

Referring to FIG. 15, a flowchart depicting a process 1500 for trust-based address rotation in a wireless device in accordance with various embodiments of the disclosure is shown. In many embodiments, the process 1500 may receive a message indicating one or more upcoming time intervals for address rotation (block 1510). The message may be transmitted by an AP deployed to provide assistance for address rotation to a plurality of stations (interchangeably referred to as “STAs”, “network devices” or “wireless stations”) connected to a network.

In a variety of embodiments, the process 1500 may identify a trust level of a connected network (block 1520). Different trust levels may include, for example, a fully-untrusted level, a semi-untrusted level, a fully-trusted level, or the like. In additional embodiments, the process 1500 may identify the trust level of the connected network based on, for example, SSID and the Authentication and Key Management (AKM) protocol utilized by the connected network. For example, the connected network can be identified as fully untrusted if the SSID of the connected network is transmitted and discoverable by any nearby devices and the AKM protocol utilized by the connected network is weak or outdated, providing little to no encryption or authentication. Similarly, the connected network can be identified as semi untrusted if the SSID is transmitted and discoverable by any nearby devices and the AKM protocol involves stronger encryption standards, providing a moderate level of security against unauthorized access. Further, the connected network can be identified as fully trusted if the SSID is not transmitted publicly, requiring devices to enter network details or use advanced discovery methods and the AKM protocol involves stronger encryption and authentication standards. In further embodiments, the process 1500 may treat the connected network as fully untrusted if the connected network is a Passpoint network (e.g., Hotspot 2.0). For example, the process 1500 may treat the network as fully untrusted if the station connects to a Wi-Fi network automatically without having to manually search for and authenticate with the network.

In several embodiments, the process 1500 may utilize predefined criteria, such as a network trust level, or the like, to select a most suitable upcoming time interval for address rotation. In several more embodiments, different network trust levels may be associated with different address rotation requirements. In an example, a Fully Untrusted Open/Opportunistic Wireless Encryption (OWE) network may require address rotation every ‘5’ minutes, a Semi Untrusted Private Shared Key (PSK) network may require address rotation every ‘10’ minutes, and a Trusted 802.1X may not require address rotation by default. In several additional embodiments, the process 1500 may have a capability to define or update a default trust level of the connected network based on the SSID and AKM.

In a number of embodiments, the process 1500 may determine whether the trust level is fully untrusted (block 1525). For example, the process 1500 may determine that the station is connected to a public Wi-Fi network which is fully untrusted. If the trust level is identified as fully untrusted, in more embodiments, the process 1500 may select, from the one or more upcoming time intervals, an upcoming time interval satisfying a first periodicity value for address rotation (block 1530). The first periodicity value may be defined or set for the fully untrusted networks. In an example, the first periodicity value may be set to ‘10’ minutes. Thus, if the connected network is fully untrusted, the process 1500 may select an upcoming time interval, from the one or more upcoming time intervals, which aligns with the 10-minute periodicity value from the previous address rotation event. In other words, if the previous address rotation had occurred at ‘10:00 AM’ and the one or more upcoming time intervals include ‘10:02 AM’, ‘10:05 AM’, ‘10:10 AM’, and ‘10:15 AM’, the process 1500 may select ‘10:10 AM’ time interval satisfying the 10-minute periodicity value. Since probing for “known networks” can inadvertently expose device's history and compromise user privacy, the process 1500 may refrain from probing for “known networks” when connected to a fully untrusted network. In other words, the process 1500 may refrain from actively searching for and identifying previously connected networks. Further, the process 1500 may avoid sending Bonjour requests for service discovery within local networks.

In yet additional embodiments, the process 1500 may transmit an opt in response for address rotation (block 1540). In other words, the process 1500 may transmit the opt in response to the AP indicating its intention to participate in the address rotation at the selected upcoming time interval. In many additional embodiments, the opt in response can include more than one selected upcoming time interval, each satisfying the first periodicity value.

However, if the trust level is not determined to be fully untrusted, in still more embodiments, the process 1500 may determine whether the trust level is semi untrusted (block 1545). If the connected network is semi untrusted, in still further embodiments, the process 1500 may select, from the one or more upcoming time intervals, an upcoming time interval satisfying a second periodicity value for address rotation (block 1550). The second periodicity value may be defined or set for the semi untrusted networks. In an example, the second periodicity value may be set to ‘5’ minutes. Thus, if the connected network is semi untrusted, the process 1500 may select an upcoming time interval, from the one or more upcoming time intervals, which aligns with the 5-minute periodicity value from the previous address rotation event. In other words, if the previous address rotation had occurred at ‘10:00 AM’ and the one or more upcoming time intervals include ‘10:02 AM’, ‘10:05 AM’, ‘10:10 AM’, and ‘10:15 AM’, the process 1500 may select at least ‘10:05 AM’ time interval satisfying the 5-minute periodicity value. Further, the process 1500 may refrain from probing for “known networks” when connected to semi untrusted network. The process 1500 may then transmit an opt in response for address rotation (block 1540).

However, if the trust level is not even semi-trusted, the trust level is identified as fully trusted. Hence, in still additional embodiments, the process 1500 may determine that address rotation is not required (block 1560). In yet more embodiments, the process 1500 may transmit an opt out response for address rotation (block 1570). In other words, in response to determining that the network is completely trusted, the process 1500 can choose not to participate in the address rotation. Such an approach may help in reducing unnecessary overhead and complexity when connected to secure and reliable networks.

Although a specific embodiment for trust-based address rotation suitable for carrying out the various steps, processes, methods, and operations described herein is discussed with respect to FIG. 15, any of a variety of systems and/or processes may be utilized in accordance with embodiments of the disclosure. For example, in still yet more embodiments, if information resource management (IRM) is detected to be in use at the STA, the process 1500 may rotate the address in accordance with the first periodicity value even if the trust level is semi untrusted or fully trusted. The elements depicted in FIG. 15 may also be interchangeable with other elements of FIGS. 1-14 and 16-19 as required to realize a particularly desired embodiment.

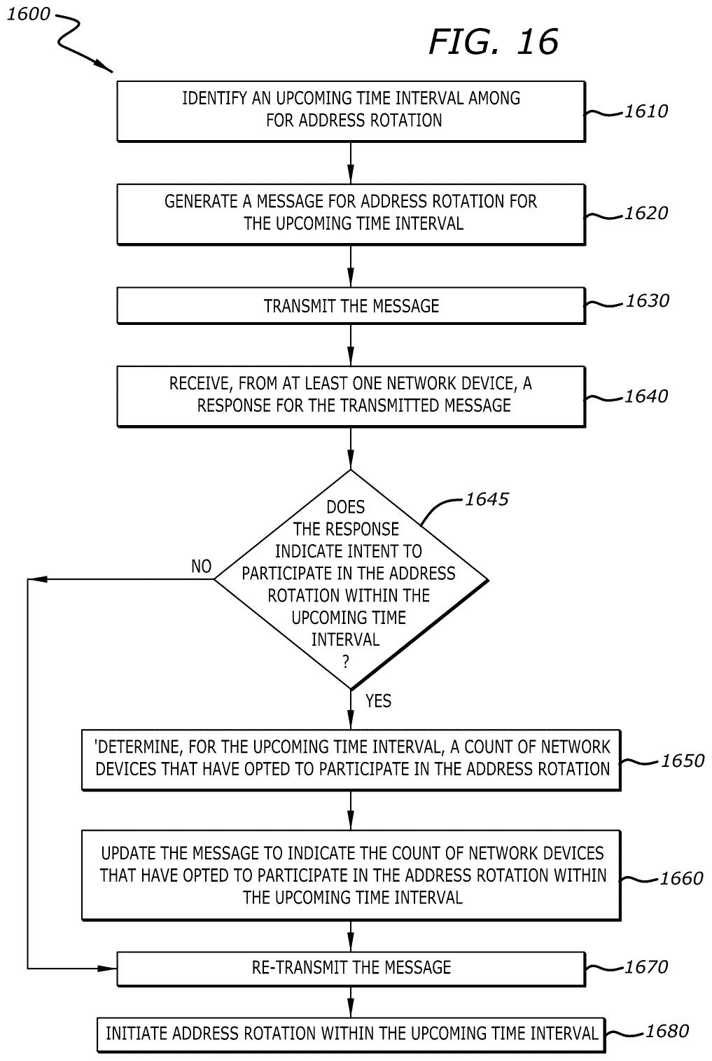

Referring to FIG. 16, a flowchart depicting a process 1600 for coordinating device address rotation in accordance with various embodiments of the disclosure is shown. In many embodiments, the process 1600 may identify an upcoming time interval for address rotation (block 1610). In several embodiments, a trust level of the network may be fully untrusted or semi untrusted and a wireless station may not trust a connected AP for coordinating address rotation. In such embodiments, the process 1600 for coordinating device address rotation may be executed at a station without AP coordination. The station may assume the role of a leader station for coordinating device address rotation. In several more embodiments, the process 1600 may identify the upcoming time interval for address rotation based on one or more privacy and security requirement of the leader STA, for privacy policies, current activity levels, network trust levels, user settings of the leader STA, or the like.

In a variety of embodiments, the process 1600 may generate a message for address rotation for the upcoming time interval (block 1620). In other words, in response to identifying the upcoming time interval, the process 1600 may generate the message that includes the details of the identified upcoming time interval. For example, if the leader station is scheduled to rotate its MAC address at the upcoming time interval, the leader station may generate an address rotation announcement (e.g., the message) to prompt other stations connected to the same network (e.g., sharing the same BSSID) to change their addresses within the upcoming time interval.

In a number of embodiments, the process 1600 may transmit the message (block 1630). In other words, the generated message is transmitted to prompt other connected stations within the network for address rotation. This transmit serves as an announcement to other stations about an upcoming address rotation event within the upcoming time interval. Thus, if the upcoming time interval is at ‘2:00 PM’, the process 1600 may transmit the prior to ‘2:00 PM’. Other stations upon receiving the transmitted message may determine whether to participate in the upcoming address rotation event. Accordingly, one or more other stations may transmit responses to the leader station.

In more embodiments, the process 1600 may receive, from at least one network device (e.g., another STA), a response for the transmitted message (block 1640). In other words, after transmitting the message, the process 1600 may wait to receive responses from other stations. In numerous embodiments, the at least one station may transmit a response to indicate its intent to participate in the address rotation. In numerous additional embodiments, the at least one station can also respond with an opt out response indicating its intent to skip address rotation in the upcoming time interval.

In additional embodiments, the process 1600 may determine whether the response indicates an intent to participate in the address rotation within the upcoming time interval (block 1645). In further embodiments, the response may include an action bit configured to indicate whether the at least one station intends to participate in the address rotation or not. For example, the action bit having a first value may indicate an intent to participate in the address rotation, while the action bit having a second value may indicate an intent to skip the address rotation.

If the response indicates an intent to participate, in many further embodiments, the process 1600 may determine, for the upcoming time interval, a count of network devices that have opted to participate in the address rotation (block 1650). For instance, if ‘15’ other stations have opted to participate in the address rotation within the upcoming time interval, the count is determined to be ‘15’.

In further additional embodiments, the process 1600 may update the message to indicate the count of network devices that have opted to participate in the address rotation within the upcoming time interval (block 1660). For example, the process 1600 may include a new field in the generated message to reflect the count of network devices participating in the address rotation within the upcoming time interval. This count of network devices opting to participate in the address rotation within the upcoming time interval may serve as a crowd obfuscation parameter that provides an indication to other stations of how well they can “hide in the crowd” if they opt to perform address rotation within the upcoming time interval. In other words, the process 1600 may switch from individual-based EDP to group-based EDP.

In still further embodiments, the process 1600 may re-transmit the message (block 1670). For example, the process 1600 may wait for a specific time period before re-transmitting the message with the count of network devices. Moreover, if the response of the at least one station indicates no intent to participate (block 1645), the process 1600 may wait for the specific time period and re-transmit the message without indicating the count of network devices (block 1670).

In still more embodiments, the process 1600 may initiate address rotation within the upcoming time interval (block 1680). In other words, the process 1600 may initiate address rotation at the designated time interval. Other stations that had opted in may also rotate their addresses (e.g., MAC addresses). However, there may be a few stations that may not rotate their MAC address at the designated time interval even though they had opted for participating in the address rotation. Further, there may be a few stations that rotate their MAC addresses at the designated time interval in spite of opting out of the address rotation at the designated time interval.

Although a specific embodiment for coordinating device address rotation suitable for carrying out the various steps, processes, methods, and operations described herein is discussed with respect to FIG. 16, any of a variety of systems and/or processes may be utilized in accordance with embodiments of the disclosure. For example, in yet more embodiments, the process 1600 may determine a minimum count of devices that need to participate in the address rotation. The transmitted message can also indicate the minimum count. In a scenario, where the minimum count is not satisfied, the process 1600 may delay the address rotation and inform the participating stations. The participating stations can either wait or continue changing their addresses as per the original designated time interval. The elements depicted in FIG. 16 may also be interchangeable with other elements of FIGS. 1-15 and 17-19 as required to realize a particularly desired embodiment.

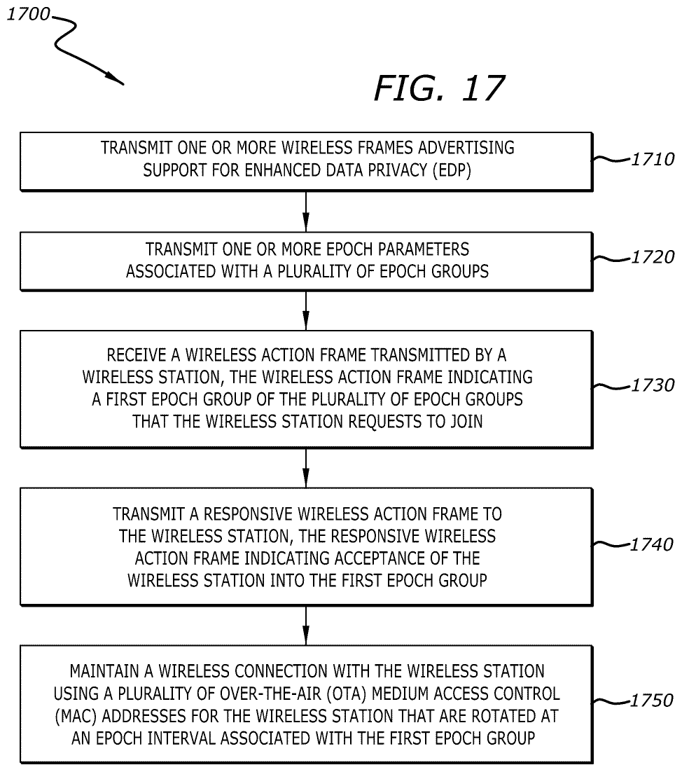

Referring to FIG. 17, a flowchart depicting a process 1700 for facilitating enhanced data privacy with group-based EDP in accordance with various embodiments of the disclosure is shown. The process 1700 may be performed at a wireless AP to enable address rotation (e.g. MAC or AID address rotation) of one or more stations connected to the AP via a wireless network to facilitate EDP. In many embodiments, the process 1700 may transmit one or more wireless frames advertising support for EDP (block 1710). That is to say, the one or more wireless frames indicate support for group-based EDP. Group-based EDP may correspond to an anonymization scheme where multiple stations change their MAC addresses concurrently at planned epochs. In other words, the process 1700 may transmit the one or more wireless frames to notify the one or more stations of its capability to support EDP, for example, group-based EDP. The one or more wireless frames may be transmitted as management frames, beacon frames, or probe responses. In an example, the one or more wireless frames may include an EPC information element (as described in the foregoing description of FIGS. 5 and 6) to indicate support for the group-based EDP.

In a number of embodiments, the process 1700 may transmit one or more epoch parameters associated with a plurality of epoch groups (block 1720). An “epoch group” may include a set of stations that have agreed for coordinated address rotation or privacy management at planned epochs. In more embodiments, after advertising the EDP support via the one or more wireless frames, the process 1700 may transmit the one or more epoch parameters associated with the plurality of epoch groups in one or more information elements of a wireless frame that advertises the one or more epoch parameters. The wireless frame can be a beacon frame (e.g., an unsolicited broadcast message) or a probe response frame (e.g., a solicited unicast message). The one or more epoch parameters may define configuration settings for address rotation for each of the plurality of epoch groups. In yet more embodiments, the one or more epoch parameters may include at least a first epoch parameter and a second epoch parameter. The first epoch parameter may include epoch timing information and the second epoch parameter may indicate a number of wireless stations participating in a corresponding epoch group of the plurality of epoch groups. In an example, the second epoch parameter may identify the number of wireless stations participating in the corresponding epoch group. In further examples, the second epoch parameter may identify a percentage of associated wireless stations participating in the corresponding epoch group. If a BSS has 40 stations and 10 of them are part of the corresponding epoch group, the percentage would be indicated as 25%. An example of the wireless frame advertising the one or more epoch parameters is described in the foregoing description of FIG. 8. The one or more epoch parameters can be advertised in an EGPA information element in the wireless frame. The one or more epoch parameters may further include unique group identifiers of the plurality of epoch groups, AID related information, or the like.

In further embodiments, the process 1700 may receive a wireless action frame transmitted by a wireless station (block 1730). The wireless action frame may be transmitted by the station as a request to join a first epoch group of the plurality of epoch groups by the STA. In several embodiments, the wireless action frame may be received after the transmission of the one or more epoch parameters. Based on the received wireless action frame, the process 1700 may determine whether the request of the station can be accepted or not. For example, the first epoch group may no longer support joining of new group members. In such a scenario, the process 1700 may determine to reject the request of the STA. However, if the first epoch group supports joining of new group members, the process 1700 may determine to accept the request of the STA. An example of the wireless action frame received from the wireless station is described in the foregoing description of FIG. 9.

In additional embodiments, the process 1700 may transmit a responsive wireless action frame to the wireless station, the responsive wireless action frame indicating acceptance of the wireless station into the first epoch group (block 1740). An example of the responsive wireless action frame transmitted to the wireless station is described in the foregoing description of FIG. 9.

In a variety of embodiments, the process 1700 may maintain a wireless connection with the wireless station using a plurality of OTA MAC addresses for the wireless station that are rotated at an epoch interval associated with the first epoch group (block 1750). In other words, once the station joins the first epoch group, the process 1700 may maintain the connection with the station based on the plurality of OTA MAC addresses rotated by the station at the epoch interval associated with the first epoch group. For example, at the epoch interval associated with the first epoch group, the station may change first OTA MAC address ‘MAC_1’ to a second OTA MAC address ‘MAC_1A’. In such a scenario, the AP may maintain a wireless connection with the station using the first and second OTA MAC addresses ‘MAC_1’ and ‘MAC_1A’ that are rotated at the epoch interval by the STA. The process 1700 may map each rotated OTA MAC address to the correct STA, preventing interruptions or conflicts.

Although a specific embodiment for facilitating enhanced data privacy with group-based EDP suitable for carrying out the various steps, processes, methods, and operations described herein is discussed with respect to FIG. 17, any of a variety of systems and/or processes may be utilized in accordance with embodiments of the disclosure. For example, in further additional embodiments, the process 1700 may advertise the one or more epoch parameters associated with the plurality of epoch groups in one or more information elements of the wireless frame. In still more embodiments, the one or more information elements of the wireless frame may include reserved fields for the second epoch parameter. For example, the reserved fields may include one or more first octets identifying the number of wireless stations participating in the corresponding epoch group. In further examples, the reserved fields may further include one or more additional octets identifying the percentage of associated wireless stations participating in the corresponding epoch group. The elements depicted in FIG. 17 may also be interchangeable with other elements of FIGS. 1-16 and 18-19 as required to realize a particularly desired embodiment.

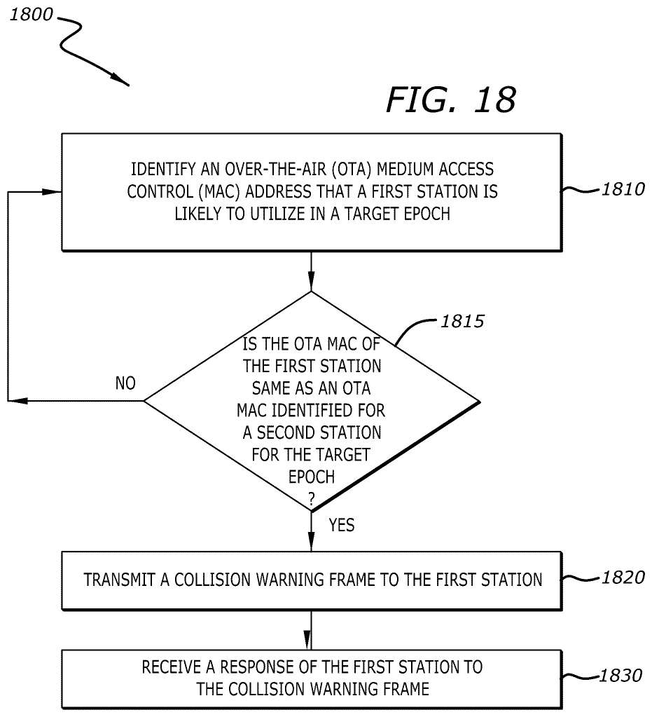

Referring to FIG. 18, a flowchart depicting a process 1800 for facilitating collision determination and avoidance during an EDP event in accordance with various embodiments of the disclosure is shown. In many embodiments, the process 1800 may be performed at a wireless AP that may be configured to transmit a warning message corresponding to a possible OTA MAC collision between two or more stations in a wireless network. In many embodiments, the process 1800 may identify an OTA MAC address that a first station is likely to utilize in a target epoch (block 1810). In a number of embodiments, the AP may utilize a predefined algorithm or mechanism that governs the derivation of OTA MAC addresses at the first station. For example, the predefined algorithm may utilize epoch parameters of the target epoch and predict the OTA MAC address that the first station is likely to utilize in the target epoch.

In several embodiments, the process 1800 may determine whether the identified OTA MAC address of the first station is same as an OTA MAC address identified for a second station for the target epoch (block 1815). In other words, the process 1800 may determine whether two or more stations are inadvertently going to rotate to the same anonymized OTA MAC address or other parameters during the target epoch. For example, the process 1800 may perform a pairwise comparison of the OTA MAC addresses identified for the target epoch.

If the process 1800 determines that the identified OTA MAC address of the first station is same as the OTA MAC address identified for the second station for the target epoch, the process 1800 may transmit a collision warning frame to the first station (block 1820). Upon determining OTA MAC address collision between the first station and the second station during the target epoch, the process 1800 may transmit the collision warning frame to instruct the first station to skip the use of the OTA MAC address designated for the target epoch, and use another OTA MAC address designated for a subsequent epoch after the target epoch. An example of the collision warning frame transmitted to the first station is described in the foregoing description of FIG. 10. A collision status field in the collision warning frame may be set to a preset value (e.g., 1) to notify the first station of possible collision with another station during the target epoch. However, if the process 1800 determines that the identified OTA MAC address of the first station is different from the OTA MAC address identified for the second station for the target epoch, the process 1800 may continue identifying OTA AMC addresses for subsequent target epochs (block 1810).

In a variety of embodiments, the process 1800 may receive response of the first station to the (block 1830). For example, upon receiving the collision warning frame from the AP, the first station may transmit a response to the AP to acknowledge or reject the MAC collision warning of the AP. An example of the response received by the AP is described in the foregoing description of FIG. 10.

Although a specific embodiment for facilitating collision determination and avoidance during an EDP event suitable for carrying out the various steps, processes, methods, and operations described herein is discussed with respect to FIG. 18, any of a variety of systems and/or processes may be utilized in accordance with embodiments of the disclosure. For example, in yet more embodiments, the process 1800 may not wait for a response from the first station, and proceed with pre-configured rules, such as automatically re-assigning MAC addresses or adjusting epoch parameters of the first station. The elements depicted in FIG. 18 may also be interchangeable with other elements of FIGS. 1-17 and 19 as required to realize a particularly desired embodiment.

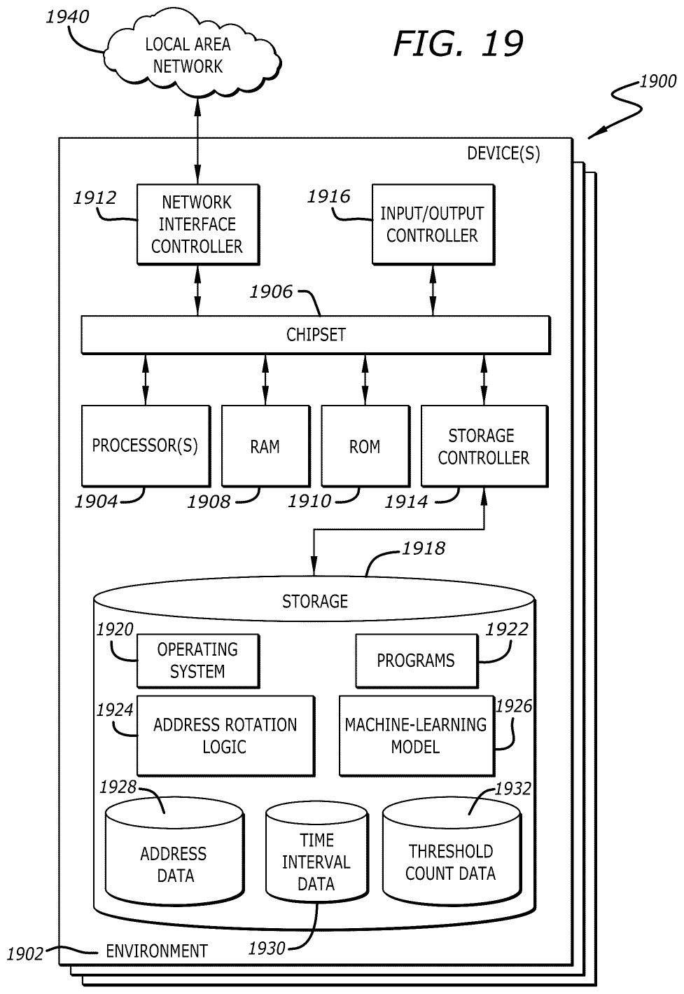

Referring to FIG. 19, a conceptual block diagram of a device 1900 suitable for configuration with an address rotation logic in accordance with various embodiments of the disclosure is shown. The embodiment of the conceptual block diagram depicted in FIG. 19 can illustrate a conventional server, switch, wireless LAN controller, AP, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 19 can also illustrate an AP, a switch, or a router in accordance with various embodiments of the disclosure. The device 1900 may, in many non-limiting examples, correspond to physical devices or virtual resources described herein.

In many embodiments, the device 1900 may include an environment 1902 such as a baseboard or “motherboard,” in physical embodiments that can be configured as a printed circuit board with a multitude of components or devices connected by way of a system bus or other electrical communication paths. Conceptually, in virtualized embodiments, the environment 1902 may be a virtual environment that encompasses and executes the remaining components and resources of the device 1900. In more embodiments, one or more processors 1904, such as, but not limited to, central processing units (“CPUs”) can be configured to operate in conjunction with a chipset 1906. The processor(s) 1904 can be standard programmable CPUs that perform arithmetic and logical operations necessary for the operation of the device 1900.

In a number of embodiments, the processor(s) 1904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1906 may provide an interface between the processor(s) 1904 and the remainder of the components and devices within the environment 1902. The chipset 1906 can provide an interface to a random-access memory (“RAM”) 1908, which can be used as the main memory in the device 1900 in some embodiments. The chipset 1906 can further be configured to provide an interface to a computer-readable storage medium such as a read-only memory (“ROM”) 1910 or non-volatile RAM (“NVRAM”) for storing basic routines that can help with various tasks such as, but not limited to, starting up the device 1900 and/or transferring information between the various components and devices. The ROM 1910 or NVRAM can also store other application components necessary for the operation of the device 1900 in accordance with various embodiments described herein.

Additional embodiments of the device 1900 can be configured to operate in a networked environment using logical connections to remote computing devices and computer systems through a network, such as the network 1940. The chipset 1906 can include functionality for providing network connectivity through a network interface card (“NIC”) 1912, which may comprise a gigabit Ethernet adapter or similar component. The NIC 1912 can be capable of connecting the device 1900 to other devices over the network 1940. It is contemplated that multiple NICs 1912 may be present in the device 1900, connecting the device to other types of networks and remote systems.

In further embodiments, the device 1900 can be connected to a storage 1918 that provides non-volatile storage for data accessible by the device 1900. The storage 1918 can, for instance, store an operating system 1920 and programs 1922 (e.g., applications). The storage 1918 can be connected to the environment 1902 through a storage controller 1914 connected to the chipset 1906. In certain embodiments, the storage 1918 can consist of one or more physical storage units. The storage controller 1914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1900 can store data within the storage 1918 by transforming the physical state of the physical storage units to reflect the information being stored. The specific transformation of physical state can depend on various factors. Examples of such factors can include, but are not limited to, the technology used to implement the physical storage units, whether the storage 1918 is characterized as primary or secondary storage, and the like.

In many more embodiments, the device 1900 can store information within the storage 1918 by issuing instructions through the storage controller 1914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1900 can further read or access information from the storage 1918 by detecting the physical states or characteristics of one or more particular locations within the physical storage units.

In addition to the storage 1918 described above, the device 1900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1900. In some examples, the operations performed by a cloud computing network, and or any components included therein, may be supported by one or more devices similar to device 1900. Stated otherwise, some or all of the operations performed by the cloud computing network, and or any components included therein, may be performed by one or more devices 1900 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1918 can store an operating system 1920 utilized to control the operation of the device 1900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1918 can store other system or application programs and data utilized by the device 1900.

In many additional embodiments, the storage 1918 or other computer-readable storage media is encoded with computer-executable instructions which, when loaded into the device 1900, may transform it from a general-purpose computing system into a special-purpose computer capable of implementing the embodiments described herein. These computer-executable instructions may be stored as programs 1922 (e.g., an application) and transform the device 1900 by specifying how the processor(s) 1904 can transition between states, as described above. In some embodiments, the device 1900 has access to computer-readable storage media storing computer-executable instructions which, when executed by the device 1900, perform the various processes described above with regard to FIGS. 1-18. In certain embodiments, the device 1900 can also include computer-readable storage media having instructions stored thereupon for performing any of the other computer-implemented operations described herein.

In many further embodiments, the device 1900 may include an address rotation logic 1924. The address rotation logic 1924 can be configured to perform one or more of the various steps, processes, operations, and/or other methods that are described above. Often, the address rotation logic 1924 can be a set of instructions stored within a non-volatile memory that, when executed by the processor(s)1904 can carry out these steps, etc. In some embodiments, the address rotation logic 1924 may be a client application that resides on a network-connected device, such as, but not limited to, a server, switch, personal or mobile computing device in a single or distributed arrangement. The address rotation logic 1924 may be configured to identify one or more upcoming time intervals for address rotation. The address rotation logic 1924 may set a threshold count on a minimum number of network devices that have to participate in the address rotation. The address rotation logic 1924 may further determine a historical count of network devices that participated in the address rotation within a historical time interval. The address rotation logic 1924 may further generate a wireless frame indicating one or more epoch parameters that may include a first epoch parameter, a second epoch parameter, and one or more of the threshold counts, a flag, or a start time for at least one of the one or more upcoming time intervals. The first epoch parameter may correspond to epoch timing information (e.g., the one or more upcoming time intervals or epoch intervals, start time, timestamp, or the like) and the second epoch parameter may indicate a number of wireless stations participating in the corresponding epoch group (e.g., the historical count of stations, percentage of stations participating in the address rotation). The second epoch parameter may be included in reserved fields provided in the message. The reserved fields may further include one or more first octets highlighting a number of stations participating in the corresponding epoch group. The reserved fields further include one or more additional octets identifying a percentage of associated stations participating in the corresponding epoch group. The address rotation logic 1924 may be further configured to encrypt the message such that the contents of the message are not leaked to an eavesdropper. The address rotation logic 1924 may transmit the message in the network to inform a schedule of address rotation. The message can be transmitted by the address rotation logic 1924 at specific time periods. The message may be transmitted in the form of one or more wireless frames that advertise support for group-based EDP. The message may be further transmitted as one or more beacon frames, one or more probe responses, one or more management frames, or the like.

The address rotation logic 1924 may be further configured to receive, from at least one network device, a response for the transmitted message. The response may be configured to indicate whether the at least one network device intends to participate in the address rotation within at least one of the one or more upcoming time intervals. For example, the response may be configured to indicate that the at least one network device intends to opt in or opt out from participating in the address rotation within the at least one of the one or more upcoming time intervals. The response may further indicate a first epoch group of a plurality of epoch groups that the station requests to join. Based on the responses received, the address rotation logic 1924 may determine a count of network devices that have opted to participate in the address rotation and may include the count in the updated message. The address rotation logic 1924 may retransmit the updated message after a specific time period. The address rotation logic 1924 may further maintain a wireless connection with the station using a plurality of OTA MAC addresses for the station that are rotated at an epoch interval associated with the first epoch group.

In some embodiments, the storage 1918 can include address data 1928. The address data 1928 can encompass various identifiers associated with network devices (e.g., wireless stations) in the network. For example, the address data 1928 may include MAC addresses or AIDs assigned to the network devices in the network. The address data 1928 may be updated after every address rotation event to include new addresses of the network devices.

In various embodiments, the storage 1918 can include time interval data 1930. The time interval data 1930 may include information about upcoming time intervals, specific time periods, or the like for address rotations. The upcoming time interval may include information about epoch boundaries within which one or more network devices perform address rotation. The specific time periods may include the periodic intervals of time at which the message is re-transmitted by the address rotation logic 1924. Further, the time interval data 1930 may include a start time of each upcoming time interval that indicates when a particular time interval may start.

In a number of embodiments, the storage 1918 can include threshold count data 1932. The threshold count data 1932 may comprise detailed information about a minimum number of network devices that have to participate in the address rotation. Each upcoming time interval may be associated with a threshold count that would indicate a sufficient number of network devices rotating their MAC addresses at the same time, to make “hiding in the crowd” effective. The threshold count data 1932 may also be referred to as the crowd obfuscation parameter that represents the density of network devices rotating MAC addresses at the same time.

In still further embodiments, the device 1900 can also include one or more input/output controllers 1916 for receiving and processing input from a number of input devices, such as a keyboard, a mouse, a touchpad, a touch screen, an electronic stylus, or other type of input device. Similarly, an input/output controller 1916 can be configured to provide output to a display, such as a computer monitor, a flat panel display, a digital projector, a printer, or other type of output device. Those skilled in the art will recognize that the device 1900 might not include all of the components shown in FIG. 19 and can include other components that are not explicitly shown in FIG. 19 or might utilize an architecture completely different than that shown in FIG. 19.

As described above, the device 1900 may support a virtualization layer, such as one or more virtual resources executing on the device 1900. In some examples, the virtualization layer may be supported by a hypervisor that provides one or more virtual machines running on the device 1900 to perform functions described herein. The virtualization layer may generally support a virtual resource that performs at least a portion of the techniques described herein.

Finally, in numerous additional embodiments, data may be processed into a format usable by a machine-learning model 1926 (e.g., feature vectors), and or other pre-processing techniques. The machine-learning (“ML”) model 1926 may be any type of ML model, such as supervised models, reinforcement models, and/or unsupervised models. The ML model 1926 may include one or more of linear regression models, logistic regression models, decision trees, Naïve Bayes models, neural networks, k-means cluster models, random forest models, and/or other types of ML models 1926.

The ML model(s) 1926 can be configured to generate inferences to make predictions or draw conclusions from data. An inference can be considered the output of a process of applying a model to new data. This can occur by learning from at least the address data 1928, the time interval data 1930, and the threshold count data 1932. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1926 may be generated by human/administrator verifications or may compare predicted outcomes with actual outcomes. In several embodiments, the ML model(s) 1926 may be configured to determine the threshold count data 1932 based on historical address rotation events. Further, the ML model(s) 1926 may be configured to identify the one or more upcoming time intervals for address rotations based on the historical address rotation events. For example, the ML model(s) 1926 may examine historical address rotation data to identify patterns or trends. By learning from historical address rotation events when the threshold count was satisfied, the ML model(s) 1926 can predict future time intervals with a high probability of satisfying the threshold count. In other words, once trained, the ML model(s) 1926 may output a schedule or recommended future time intervals for future address rotation events where the threshold count is likely to be satisfied.

Although a specific embodiment for a device suitable for configuration with the networking logic for carrying out the various steps, processes, methods, and operations described herein is discussed with respect to FIG. 19, any of a variety of systems and/or processes may be utilized in accordance with embodiments of the disclosure. For example, the device 1900 may be in a virtual environment such as a cloud-based network administration suite, or it may be distributed across a variety of network devices or APs. The elements depicted in FIG. 19 may also be interchangeable with other elements of FIGS. 1-18 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A method, comprising:
transmitting, by an access point, one or more wireless frames advertising support for enhanced data privacy (EDP), wherein the one or more wireless frames indicate support for group-based EDP;
transmitting, by the access point, one or more epoch parameters associated with a plurality of epoch groups, wherein a first epoch parameter of the one or more epoch parameters comprises epoch timing information and a second epoch parameter of the one or more epoch parameters indicates a number of wireless stations participating in a corresponding epoch group of the plurality of epoch groups;
receiving, by the access point, a wireless action frame transmitted by a wireless station, wherein the wireless action frame indicates a first epoch group of the plurality of epoch groups that the wireless station requests to join; and
maintaining a wireless connection with the wireless station using a plurality of over-the-air (OTA) medium access control (MAC) addresses for the wireless station that are rotated at an epoch interval associated with the first epoch group.

2. The method of claim 1, further comprising transmitting, by the access point, a responsive wireless action frame to the wireless station, the responsive wireless action frame indicating acceptance of the wireless station into the first epoch group.

3. The method of claim 1, wherein the one or more wireless frames advertising support for EDP are beacon frames.

4. The method of claim 1, wherein the one or more wireless frames advertising support for EDP are probe response frames.

5. The method of claim 1, wherein the second epoch parameter identifies the number of wireless stations participating in the corresponding epoch group.

6. The method of claim 1, wherein the second epoch parameter identifies a percentage of associated wireless stations participating in the corresponding epoch group.

7. The method of claim 1, wherein the one or more epoch parameters associated with the plurality of epoch groups are transmitted in one or more information elements of a wireless frame that advertises the one or more epoch parameters.

8. The method of claim 7, wherein the one or more information elements each comprise reserved fields for the second epoch parameter.

9. The method of claim 8, wherein the reserved fields comprise one or more first octets identifying the number of wireless stations participating in the corresponding epoch group.

10. The method of claim 9, wherein the reserved fields further comprise one or more additional octets identifying a percentage of associated wireless stations participating in the corresponding epoch group.

11. A wireless access point, comprising:
at least one memory element for storing data; and
at least one processor for executing instructions associated with the data, wherein executing the instructions causes the wireless access point to perform operations, comprising:
transmitting one or more wireless frames advertising support for enhanced data privacy (EDP), wherein the one or more wireless frames indicate support for group-based EDP;
transmitting one or more epoch parameters associated with a plurality of epoch groups, wherein a first epoch parameter of the one or more epoch parameters comprises epoch timing information and a second epoch parameter of the one or more epoch parameters indicates a number of wireless stations participating in a corresponding epoch group of the plurality of epoch groups;
receiving a wireless action frame transmitted by a wireless station, wherein the wireless action frame indicates a first epoch group of the plurality of epoch groups that the wireless station requests to join; and
maintaining a wireless connection with the wireless station using a plurality of over-the-air (OTA) medium access control (MAC) addresses for the wireless station that are rotated at an epoch interval associated with the first epoch group.

12. The wireless access point of claim 11, wherein the operations further comprise transmitting a responsive wireless action frame to the wireless station, the responsive wireless action frame indicating acceptance of the wireless station into the first epoch group.

13. The wireless access point of claim 11, wherein the one or more wireless frames advertising support for EDP are beacon frames.

14. The wireless access point of claim 11, wherein the one or more wireless frames advertising support for EDP are probe response frames.

15. The wireless access point of claim 11, wherein the second epoch parameter identifies a number of wireless stations participating in the corresponding epoch group.

16. The wireless access point of claim 11, wherein the second epoch parameter identifies a percentage of associated wireless stations participating in the corresponding epoch group.

17. The wireless access point of claim 11, wherein the one or more epoch parameters associated with the plurality of epoch groups are transmitted in one or more information elements of a wireless frame that advertises the one or more epoch parameters.

18. The wireless access point of claim 17, wherein the one or more information elements each comprise reserved fields for the second epoch parameter.

19. The wireless access point of claim 18, wherein the reserved fields comprise one or more first octets identifying a number of wireless stations participating in the corresponding epoch group.

20. The wireless access point of claim 19, wherein the reserved fields further comprise one or more additional octets identifying a percentage of associated wireless stations participating in the corresponding epoch group.
